(19) United States
(12) Patent Application Publication
(10) Pub. No.: US 2010/0212783 A1
(43) Pub. Date: Aug. 26, 2010

(54) FLAIL CHAIN

(76) Inventors: John J. McCauley, Winona, MN (US); Robert D. Jensen, Winona, MN (US)

Correspondence Address: Moore & Hansen, PLLP, 225 South Sixth Street, Suite 4850, Minneapolis, MN, 55402, US

(21) Appl. No.: 12/776,364

(22) Filed: May 7, 2010

Related U.S. Application Data
(63) Continuation-in-part of application No. 11/279,502, filed on Apr. 12, 2006.
(60) Provisional application No. 60/671,012, filed on Apr. 13, 2005.
(60) Provisional application No. 61/176,408, filed on May 7, 2009.
(60) Provisional application No. 61/304,072, filed on Feb. 12, 2010.

(51) Int. Cl. B27L 1/00; B21L 3/00

(52) U.S. Cl. 144/208.7; 59/35.1

(57) ABSTRACT

Flail chain including interlocking chain links, at least one chain link being a passing link, the passing link having first and second segments and outer and inner perimeters, wherein the first segment is generally semi-circular and includes a weld section and the second segment includes a stabilizing portion on the outer perimeter opposite the weld section. The first segment includes rounded portions on each side of the weld section and the second segment including two rounded ends on each side of the stabilizing portion and the two rounded ends being continuous with rounded ends of the first segment. The stabilizing portion including at least two spaced apart points on the outer perimeter that stabilize the link on a surface such that the link can slide on the surface without changing its orientation relative to the surface. The invention further includes debarking devices and methods of manufacturing flail chains.

### RELATED APPLICATIONS

The present application (1) is a continuation-in-part of U.S. patent application Ser. No. 11/279,502, filed on Apr. 12, 2006, which claims benefit of U.S. Provisional Application Ser. No. 60/671,012, filed Apr. 13, 2005; (2) claims benefit of U.S. Provisional Application Ser. No. 61/176,408, filed May 7, 2009; and (3) claims benefit of U.S. Provisional Application Ser. No. 61/304,072, filed Feb. 12, 2010; all of which are herein incorporated by reference.

### FIELD OF THE INVENTION

The present invention relates to flail chains. The invention also relates to debarking devices or apparatus that includes a plurality of flail or debarking chains. The invention further relates to methods of manufacturing such flail chains.

### BACKGROUND OF THE DISCLOSURE

It is well known that bark and limbs can be removed from trees or logs in a debarking device by passing the tree or log between one or more rapidly rotating, upper and lower debarking or flail drums in the debarking device, each of which have a plurality of debarking chains, also commonly called flail chains. The debarking chains repetitively strike the surface of the log with significant force at a high rate of speed, effectively tearing away any small limbs and virtually all of the bark on the log in preparation for a chipping operation in which the log is chipped into small pieces appropriate for wood pellet stoves or for further processing into wood pulp for paper manufacturing or the manufacturing of composite products such as chip board, oriented strand board and engineered lumber.

Logs are conveyed lengthwise through the debarking device along a predetermined feed plane. The upper flail drum or drums are located above the feed plane and the lower flail drum or drums are located below the feed plane. Flail drums typically rotate about a generally horizontal axis transverse to the path of travel of the tree or logs, each at a distance from the feed plane to allow the debarking chains, or flail chains, together to clear bark and limbs from the surface of the log. It will be appreciated that each set of debarking chains, associated with respective debarking drums, should ideally reach at least the midpoint of the sides of the log. Some debarking devices have additional debarking drums some of which are fixed drums and some of which are often “floating” drums.

It will be appreciated that in prior designs, the debarking chains consist of elongated or oblong chain links that have both a projected wear pattern and a projected wear life based primarily upon impact and link-to-link wear, especially to the u-shaped end portion of each of the respective chain links as links repetitively strike the outer surface of the logs and as 1) these respective adjacent links strike each other, generally on the inner surface of the respective links, when the links recoil following such impacts, and 2) links are struck by next to adjacent links, generally on the outer surface of the link, when the links recoil following impact. This projected wear pattern generally dictates frequency of debarking chain flipping and replacement. The cost of replacement of chipper parts that results from flail chain breakage is so great that flail chains are generally flipped or replaced well before they are projected to break. Nevertheless, it will be appreciated that any extension of the projected wear life of a set of debarking chains will reduce cost for debarking operations both because extended use will reduce the number of chains used per unit of logs debarked or wood chips generated, and because improved productivity will by realized due to less downtime associated with chain flipping or replacement.

In normal use, a set of debarking chains are generally attached to a debarking drum, typically used for a predetermined amount of time or until any links are worn to a predetermined amount of wear near the point of breakage based on periodic inspection of the debarking chain, and then typically disconnected, flipped end to end, before being reattached and used again for another set amount of time or predetermined amount of wear.

Debarking is important in chipping operations, because this processing step minimizes the residual amount of bark mixed into wood chips during subsequent chipping and chip processing operations. Wood chips are less desirable for pulping operations when they contain bark that is not removed from logs before the logs are chipped and generally lower the value of the chips to buyers or users.

### SUMMARY OF THE INVENTION

The present invention includes a flail chain having a plurality of adjacent, interconnected chain links, at least one of which is a passing link, which is rotatable with respect to adjacent links. Such a flail chain can be used as a debarking chain configured for attachment to a debarking drum. In preferred embodiments, all of the respective links are passing links produced in a continuous process. Debarking chain includes a plurality of interconnected chain links, each chain link being manufactured from a continuous strand of chain material surrounding and defining a central opening through which the continuous strand of any adjacent, interconnected chain links pass. If the chain links are standard oblong chain links they will not generally rotate with respect to adjacent links and the stress from the continuous impact on the interior surface of each link will be concentrated in the u-shaped ends of the oblong chain links. The passing links are constructed and arranged to permit the passing links to rotate or turn with respect to both adjacent chain links during use in such a manner that allows the concentration of impact, stress and wear on the passing link to be minimized. It is desirable to use a flail chain made entirely of passing links, because passing links rotate with respect to adjacent chain links, thereby randomly distributing the stress from the impact of adjacent chain links during use, which is believed to extend the wear life of the flail chain. Making such a flail chain in a continuous process, however, is challenging because there is a tendency for round chain links to roll during a continuous chain link formation and welding process, which makes accurately positioning the chain link for welding difficult in systems currently in use. The preferred flail chain includes a plurality of interlocking chain links, at least one chain link being a passing link. The preferred passing link has first and second segments and outer and inner perimeters, wherein the first segment is generally semi-circular and includes a weld section and the second segment includes a stabilizing portion on the outer perimeter opposite the weld section. The first segment includes rounded ends on each side of the weld section having curved inner and outer perimeters; the second segment further includes two rounded ends on each side of the stabilizing portion, the two rounded ends being continuous with the first segment. The preferred stabilizing portion includes at least two spaced apart contact points on the outer perimeter that can stabilize the link on a flat surface such that the link can slide on the surface without rolling or changing its orientation to the surface. In preferred passing links, the stabilizing portion is a substantially flat or flattened portion, such that when the debarking chain is manufactured, the respective passing link will be less likely to rotate and move out of position during the transfer from the bending or forming machine to the welding machine, thus making continuous resistance upset welding feasible. Preferably, the substantially flat portion is opposite the weld section. It is preferred that the debarking chains be manufactured with automatic processes, including continuous resistance upset welding, to reduce cost. Therefore, the preferred flail chains include a plurality of interlocking passing links of a generally uniform configuration.

The debarking chain may also include at least one drum attachment chain link or end link; the drum attachment chain link being at a first end of a debarking drum and being constructed and arranged to be secured to the debarking drum. The debarking chain can have a drum attachment chain link at each end of the debarking chain, which is generally an oblong chain link constructed to correspond to an opening in an outer surface of the debarking drum in which an end link of a debarking chain can be inserted and secured in a number of existing debarking drums. Alternatively, debarking drums being configured to receive chains having passing links for end links may be used and are preferred.

The preferred flail chains can also be used for such flail applications as quarrying, soil treatment, demining and processing, cleaning or removing debris. The preferred flail chains can also be used for other non-flail applications such as curtain chain and kiln chain, for example.

The preferred flail chain includes passing links that preferably have a substantially flattened portion on the outer perimeter such that when the debarking chain is manufactured, the respective passing link will be less likely to rotate and move out of position during the transfer from the bending or forming machine to the welding machine, thus making continuous resistance upset welding feasible. Preferably, the substantially flat portion is opposite the weld section. It is preferred that the debarking chains be manufactured with automatic processes, including continuous resistance upset welding, to reduce cost. Therefore, the preferred flail chains include a plurality of interlocking passing links of a generally uniform configuration.

One preferred method of manufacturing a flail chain includes the steps of first providing a bulk length of wire material having a lead end. The lead end is then fed into a wire forming machine. The method further includes creating a plurality of chain link blanks in series by separating away a portion of wire material proximate the lead end of the length of wire material to create the respective chain link blanks, each of which has respective first and second ends. The plurality of chain link blanks are then consecutively bent into unwelded formed links in series such that the respective first and second ends of each chain link blank are turned toward one another and there is a gap between the respective ends on one side of each of the respective unwelded formed links and a stabilizing portion on an outer perimeter of each of the respective unwelded formed links on the side opposite the gap; wherein the step of consecutively bending each of the chain link blanks includes creating an unwelded chain including a plurality of interlocking unwelded formed links from the consecutively bent plurality of chain link blanks. The stabilizing portion preferably includes at least two spaced apart contact points on the outer perimeter that can stabilize the respective unwelded formed link on a flat surface such that the respective unwelded formed link can slide and rest on the flat surface without rolling or changing its orientation relative to such flat surface. The method further includes creating a series of flail chains each including a plurality of interlocking, welded passing links by transporting the unwelded chain to a welding machine where the gap of each of the plurality of interlocking unwelded formed links is welded in series such that each of the respective unwelded formed links becomes a welded passing link having first and second segments and outer and inner perimeters, wherein the first segment is generally semi-circular and includes a weld section and the second segment includes a stabilizing portion on the outer perimeter opposite the welded section. The first segment includes rounded portions on each side of the welded section having curved inner and outer perimeters and the second segment further includes two rounded ends on each side of the stabilizing portion, the two rounded ends being continuous with the first segment and the stabilizing portion including at least two spaced apart contact points on the outer perimeter that can stabilize the link on a flat surface such that the link can slide and rest on the surface without rolling or changing its orientation relative to such flat surface. A welding machine is provided and the welding machine includes a welding block having a longitudinal surface that is generally flat. The step of creating includes a step of welding wherein each of the respective unwelded formed links are consecutively transported onto the longitudinal surface of the welding block so as to stabilize each of the respective unwelded formed links during the welding step such that the respective gaps are consecutively welded and a series of interlocking, welded passing links are created; and wherein, following the step of welding, the step of creating further preferably includes a step of cutting wherein a series of the interlocking, welded passing links are cut to enable a series of flail chains to be separated from the series of interlocking, welded passing links created during the welding step.

As discussed above, to best manufacture flail chains of the present invention, a transfer section between the bending and welding equipment preferably includes a generally v-shaped bar or guide on which the continuously formed chain passes before it is fed into the welding machine. The generally v-shape guide contacts the chain at the flattened portions on the outer perimeter of the respective individual links such that the continuous chain does not rotate as the chain moves along that v-shaped guide.

The present invention also includes debarking devices having at least one debarking drum including a plurality of debarking chains. Preferably, the debarking chains are those including at least one passing link as discussed herein. In preferred embodiments, this debarking device will also include or be associated with a chipping device constructed and arranged to chip a wood log into small wood chips suitable for further processing in the pulp, wood pellet or composite lumber industries. It will be appreciated that it is important to remove bark from such logs prior to the chipping operation in this process.

It will be further understood that the debarking or flail chains of the present invention can be used for numerous flailing operations and are not limited to debarking operations. Such other uses or applications, include, but are not limited to quarrying, soil treatment, demining, and processing, cleaning or removing debris.

These and various other advantages and features of novelty which characterize the present invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described a preferred embodiment of the present invention.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown:

FIG. 1 is a side elevation view of a schematic illustration of a prior art debarking/delimbing apparatus 10 having flail chains 26;

FIG. 2 is a side elevation of a schematic illustration of a debarking/delimbing/chipping apparatus 110 of the present invention utilizing debarking or flail chains 126 having substantially round passing links 140;

FIG. 3 is a perspective view of an alternate debarking drum 220 showing a rod 228 that is removed so that the debarking chains 226 secured by the rod 228 can be detached from the debarking drum 22 and be replaced or flipped;

FIG. 4 is a cross-sectional view of the alternate debarking drum 222 illustrated in FIG. 3 as seen from the line 4-4 of FIG. 3;

FIG. 5 is a top view illustrating an alternate debarking or flail chain 326 having five links, two of which are passing links 340;

FIG. 6 is a top view illustrating an alternate debarking or flail chain 426 having seven links, two of which are passing links 440;

FIG. 7 is a top view illustrating an alternate debarking or flail chain 526 having seven links, four of which are passing links 540;

FIG. 8 is a top view illustrating an alternate debarking or flail chain 626 having six links, two of which are passing links 640;

FIG. 9 is a top view illustrating an alternate debarking or flail chain 726 having eight links, six of which, i.e. every link except for the two end links, is a passing link 740;

FIG. 10 is a top view illustrating an alternate debarking or flail chain 826 having eleven links, where five of the links are passing links 840;

FIG. 11A is a top view illustrating an alternate debarking or flail chain 926 having nine links, four of which are passing links 940; this alternate debarking chain is the same as those chains used in Test No. 3, reported in Example I below;

FIG. 11B is a top view illustrating an alternate debarking or flail chain 1026 having nine links, all of which are passing links 1040;

FIG. 11C is a top view illustrating an alternate debarking or flail chain 1126 having eight links, all of which are passing links 1140;

FIG. 12 is a bar graph and line graph that graphically illustrates the data reported in Table 1, discussed in Example I, below; and

FIG. 13A is a plan view of the passing link 140 at various stages of forming and pre and post-welding;

FIG. 13B is a plan view of the preferred passing link 140;

FIG. 14A is a schematic illustration of a portion of a bulk length of wire material 1052 being fed into a bending machine 1060;

FIG. 14B is a schematic illustration of the portion of wire material 1052 of FIG. 14A as it is notched by first and second dies 1064a, 1064b of the bending machine 1060;

FIG. 14C is a schematic illustration of a chain link blank 1056 is separated from the portion of wire material 1052;

FIG. 14D is a schematic illustration of the chain link blank 1056 of FIG. 14C as it is further formed into a generally C-shaped configuration;

FIG. 14E is a schematic illustration of the chain link blank 1056 of FIG. 14D before it becomes interlinked with a chain of unwelded links 1036;

FIG. 14F is a partial-cutaway, schematic top illustration of the chain link blank 1056 of FIG. 14E as it becomes interlinked with the chain of unwelded links 1036;

FIG. 14G is a schematic front illustration of the chain of unwelded links 1036 of FIG. 14F;

FIG. 14H is a schematic side view of the chain of unwelded links 1036 of FIG. 14G illustrating how the most recently formed unwelded formed link 1038 is then rotated about ninety degrees to receive the next formed link (not shown);

FIG. 14I is a schematic illustration of the chain of unwelded links 1036 of FIG. 14H as it exits the bending machine 1060 and is transported to a welding machine having a welding machine 1090;

FIG. 14J is a schematic illustration of the chain of unwelded links 1036 of FIG. 14I as a link is being welded onto a saddle 1092 of the welding machine 1090;

FIG. 14K is a schematic illustration of a weld section 1044 of the link of FIG. 14J before it is deburred by trimmer 1098 (only one trimmer is shown for clarity);

FIG. 15A is a top view of a preferred v-shaped transition channel 1080 between the bending machine 1060 and the welding machine's welding machine 1090;

FIG. 15B is a cross-sectional, side view of the preferred v-shaped transition channel 1080 of FIG. 15A;

FIG. 15C is a partial, cross-sectional view as viewed from lines 15C-15C of

FIG. 15B of the chain of unwelded links 1036 within the v-shaped transition channel 1080 of FIGS. 15A-15B;

FIG. 16A is a top view of a second transition channel 1086 between the bending machine 1060 and the welding machine 1090;

FIG. 16B is a cross-sectional, side view of the transition channel 1086 of FIG. 16A;

FIG. 17 is a perspective view of a debarking device 210′;

FIG. 18 is a partial, front view of a debarking drum 220′ of debarking device 210′; and

FIG. 19 is a partial, front view of the debarking drum 220′ after substantial use illustrating worn flail chains 1026′ and the debarking drum 220′.

### DETAILED DESCRIPTION OF THE PREFERRED EMBODIMENTS

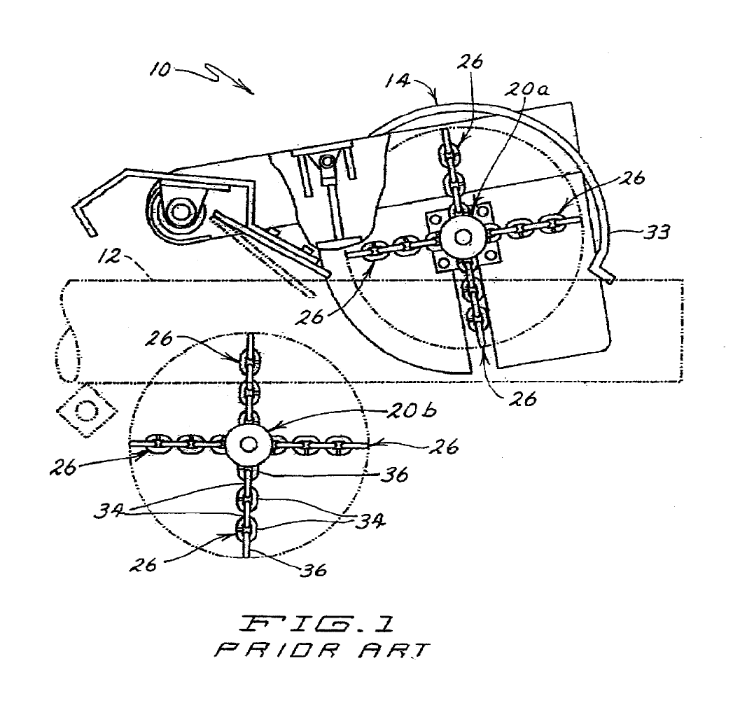

Debarking devices are commonly used in the wood pulp, wood pellet and composite lumber industries to remove bark and small limbs from the surface of a log prior to chipping of the log. As shown in the prior art illustration of FIG. 1, one known embodiment of a debarking/delimbing apparatus 10 includes upper and lower debarking units 14 and 16, respectively, having a plurality of flail or debarking chains 26. Each debarking chain 26 is constructed of multiple elongated or oblong chain links 34, which are used to flail the surface of a log 12 to remove bark and limbs. The useful life of known debarking chains is limited by the impact and wear on the respective chain links at the point where adjacent or next to adjacent oblong chain links 34 make contact with adjacent and next to adjacent links when the chain 26 strikes the log 12. The elongated shape of such typical chain links is believed to lead to repetitive wear from such stress and such impacts, generally in the same place on the inside and outside surfaces of the rounded portion in the u-shaped end of each link 34. This repetitive wear diminishes the material in these areas and also places repetitive stress upon these areas resulting in a higher degree of metal fracture; all of which results in a limitation on the useful life of such debarking chains 26.

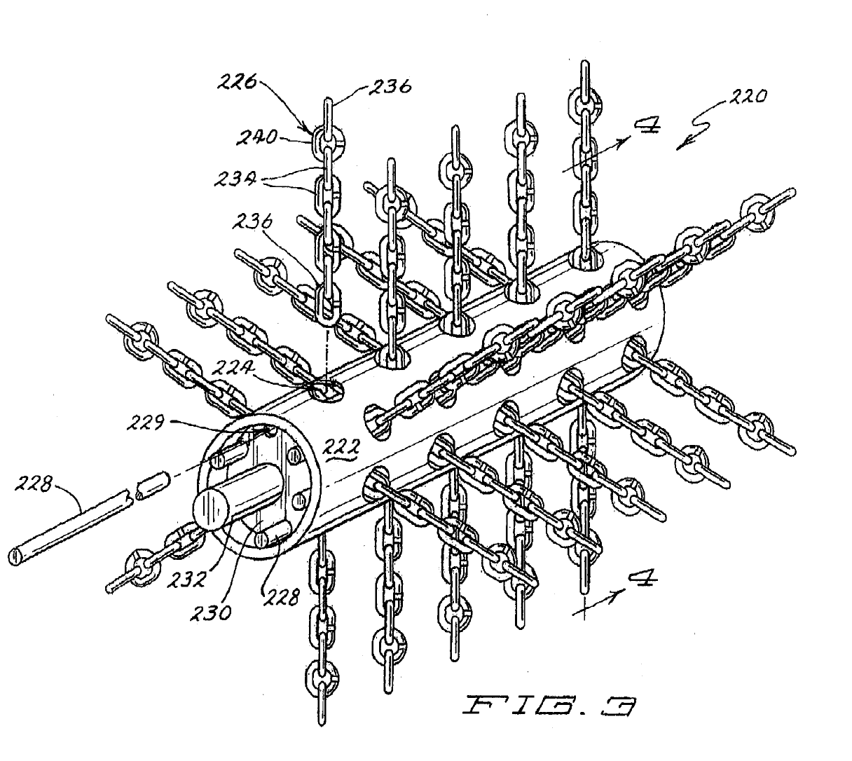

The prior art debarking/delimbing apparatus 10 shown in FIG. 1 is representative of other similar prior art devices, which also have one or more upper and one or more lower debarking units 14, 16 having debarking drums 20a, 20b. In many cases, such similar prior art devices will include additional debarking units (not shown) spaced away from the first two units 14, 16. In many cases, the upper debarking drum 20a is a “floating” unit and the lower debarking drum 20b is in a fixed position, as these respective drums 20a, 20b are. The term “floating” is used to describe a vertically self-adjusting ability. As logs 12 of different diameters are inserted into the debarking unit 14, the debarking unit 14 will pivot up or down in order to accept the log 12 while still remaining close enough to the log 12 in order to debark/delimb. Each debarking drum 20a, 20b may include a cylindrical plate (not shown) similar to the cylindrical plate 222, shown in a debarking drum 220 of the present invention illustrated in FIG. 3, in which the plate 222 has a series of chain receiving openings or pockets 224 in which an end link 236 of one or more debarking chain 226 can be received and subsequently secured by a securing rod 228, secured by various means known in the art within openings 229 within a hub or hubs 230. The hubs 230, through which a shaft 232 is also secured, permit the debarking drums 20a, 20b to rotate relative to a housing 33. The securing rods 228 are often secured within respective hubs 230 by threaded fasteners (not shown). With respect to certain debarking devices, the threaded fasteners can be further secured to reciprocally threaded ends on the debarking drum (not shown).

It will be appreciated that the debarking drums 20a, 20b rotate at a very high rate of speed and that the debarking chains 26 strike the logs 12 with great force as the logs 12 enter the debarking/delimbing apparatus 10. A great deal of this force is directed to points along the inner and outer boundary of each of the respective chain links as they strike adjacent and next to adjacent links and against the outer surface of links as they strike the log. It is commonly observed by persons familiar with debarking/delimbing operations that this is especially the case for the link that is the second from the end closest to the log of any secured debarking chain 26 and also for the link that is third from the end. Indeed, wear to the point of breakage is most often observed in the prior art debarking chains at the second or third link from the end farthest from the drum and closest to the log. The reason for these second and third links of the prior art being most prone to wear and breakage is generally believed to be as follows: 1) the end link closest to the log is free to rotate about its contact area with the adjacent second link. Therefore, impact on the inner and outer circumferential surfaces of the end link is distributed, whereas the contact point on the second link associated with impact from the end link is largely confined to the u-shaped radius of the end of the second link closest to the end link. Moreover, 2) the end link also strikes the outside surface of the u-shaped end of the third link that is closest to the log, while the inside surface of the u-shaped end of the second link impacts the inside surface of the u-shaped end of the third link, thus creating wear in an area of the third link, concentrated in the prior art debarking chains, to the inside and outside perimeters of the u-shaped end closest to the log. This is the main reason that debarking chains are typically disconnected and then “flipped” end for end, before being reconnected and used again, because “flipping” the chain allows for more even distribution of wear, thereby, extending the wear or useful life for each of the debarking chains used in this way.

It will be appreciated, however, that, except for unsecured end links 36, oblong links such as those included in the prior art debarking or flail chains 26, shown in FIG. 1, do not readily change orientation, turn or rotate with respect to adjacent links during use; and the wear and stress from the impact of the respective links 34 is generally concentrated in the rounded, u-shaped ends of these oblong chain links. It is an object of the present invention to more equally distribute the stress and wear associated with the repetitive impact to the entire inner and outside perimeter of links along the length of a debarking chain.

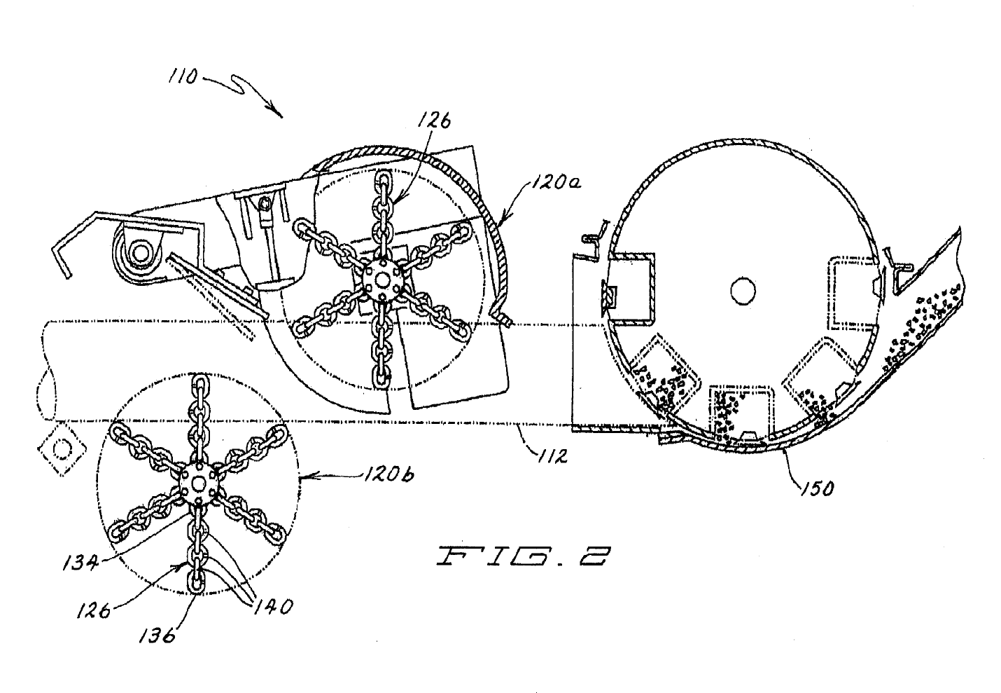

Referring now to FIGS. 2 through 11C, the debarking/delimbing/chipping apparatus 110 of the present invention preferably includes a debarking drum 120a, 120b, each debarking drum having at least one preferred debarking or flail chain 126, each of which preferably includes a plurality of interlocking chain links, many which are passing links 140. In the embodiment shown in FIG. 2, each of the chain links of each of the debarking chains 126 are passing links 140, with the exception of the end links 136 on each flail chain 126. In these embodiments, the debarking chains 126 include end links 136 that are elongated, oblong chain links, like those in the prior art debarking chains 26 shown in FIG. 1. It is believed that for various embodiments, it is important for the end links 136 at each end of certain debarking chains 126 of the present invention, to be an oblong link so that these end links 136 will fit easily into chain receiving openings or pockets (not shown) similar to the pockets 224 shown in FIG. 3 that are common in debarking units that are presently used throughout the wood chipping/wood pulping industry. It will be appreciated, however, that a redesigned debarking drum, including a connecting member to connect alternate debarking chains of the present invention (not shown), that are made entirely of substantially round passing links, are envisioned as falling within the scope of the present invention. It will further be appreciated that present debarking drums can be modified to increase the size of the pocket such that one or more substantially round passing links will fit into the pocket and be used.

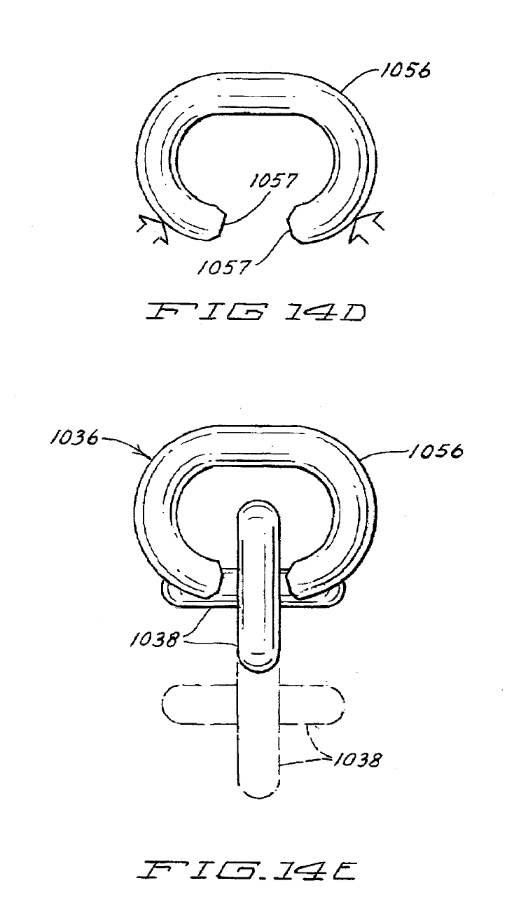

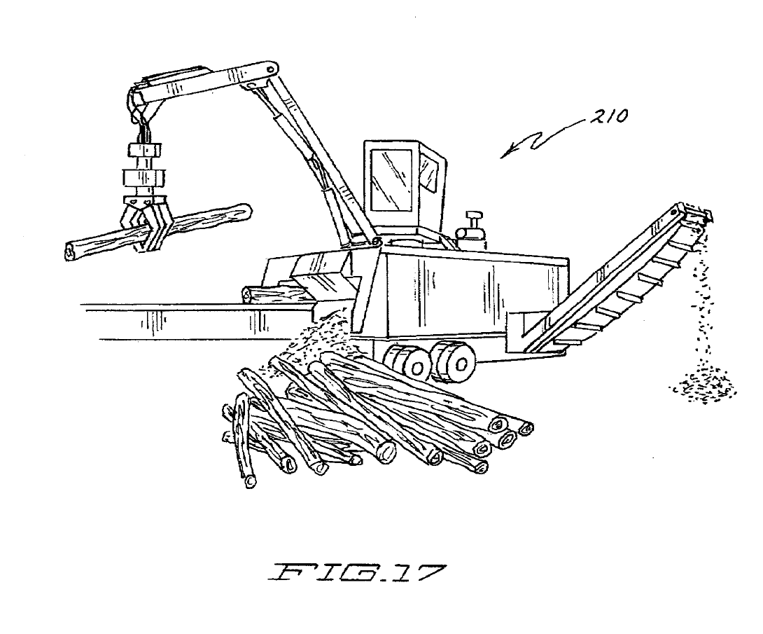

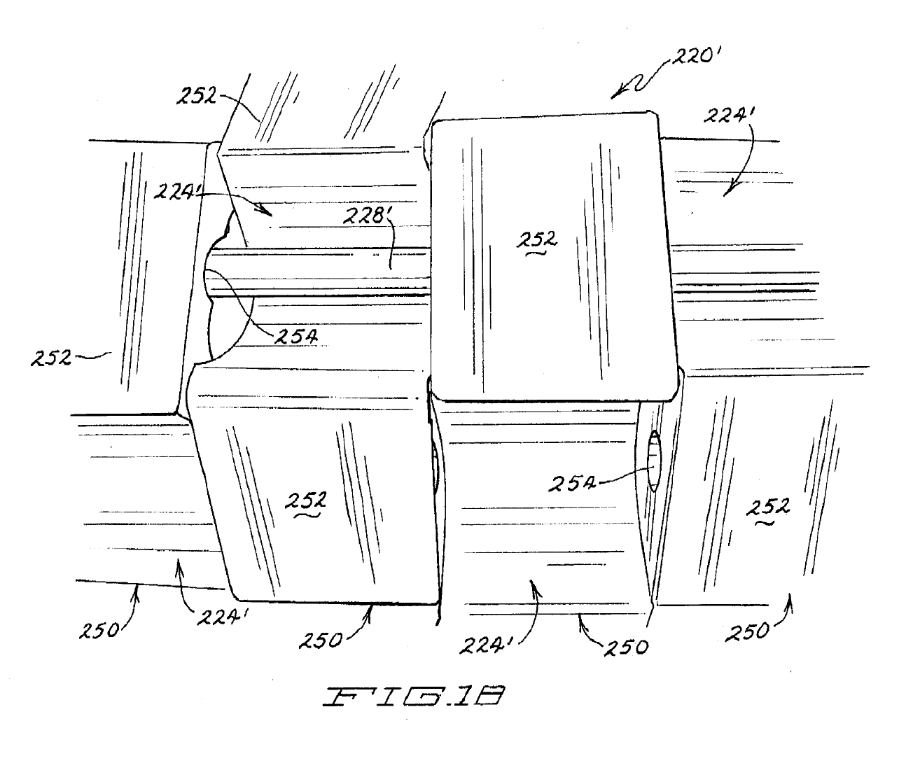

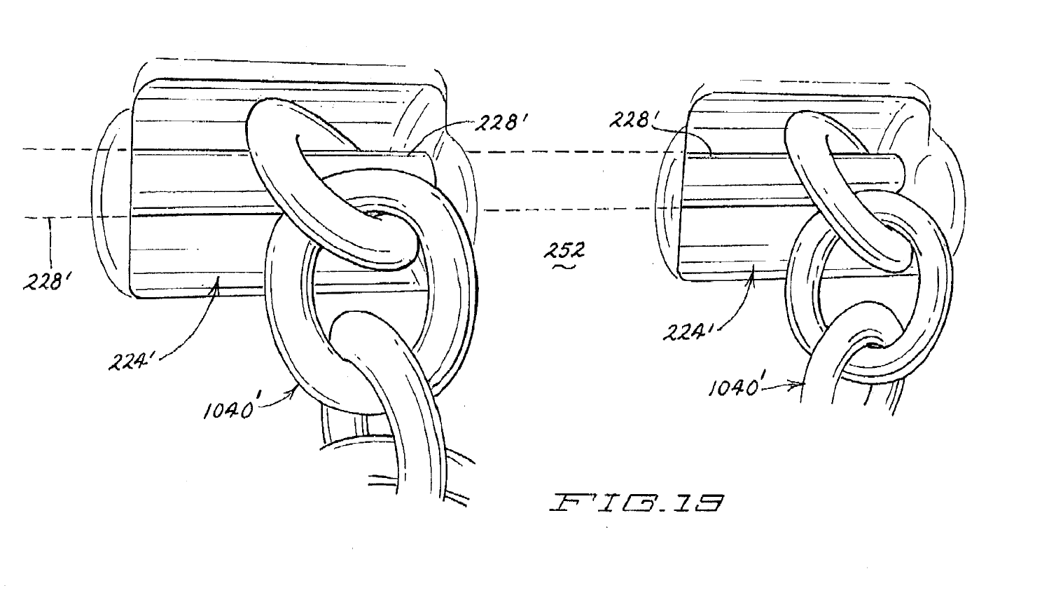

For example, FIG. 3 illustrates an alternate debarking drum 220 similar in many ways to a debarking drum of debarking apparatus model numbers 2755 Flail Chiparvestor or 2355 Flail Chiparvestor, sold by Morbark of Winn, Mich. Alternate debarking devices, such as that illustrated in FIGS. 17-20, include debarking drums 220′ having a plurality of clover-shaped sections 250 stacked together along a shaft (not shown) in a key-like engagement relationship (see also, U.S. Pat. No. 5,148,844 (Robison)), the disclosure of which is herein incorporated by reference). Each clover-shaped section 250 includes a plurality of radial protrusions 252, preferably four (4). The cover-shaped sections are positioned such that they alternate and form pockets 224′ and mating passages for typically six (6) or eight (8) securing rods 228′ to be installed. The preferred debarking devices, however, have pockets 224′ that have been enlarged by opening the gaps between the clover protrusions 252, such that debarking chains having passing links for end links can be secured to the securing rods 228′ (note in FIG. 18, only one rod 228′ is shown for clarity). As illustrated in FIGS. 11B-11C, for example, the preferred debarking apparatus includes flail chains 1026, 1126 having only passing links 1040, 1140. It will be understood, however, that flail chains 140, 240, 340, 440, 540, 640, 740, 840, 940 or the like can also be used and are used within the scope of the invention. After use of such debarking device 210′, the drum 220′ will likely wear such that the clover-shaped sections 250 become generally indistinguishable and become somewhat cohesive as is generally illustrated in FIG. 19. FIG. 19 further illustrates a substantially worn debarking chain 1026′, which has somewhat changed the characteristics of the links 1040′.

As defined herein, a “passing” link is a chain link that can substantially rotate, substantially turn or substantially change its orientation with respect to any immediately adjacent links during use as one of a series of links in a debarking chain, when the chain is used as a debarking chain in a flailing or debarking operation, without necessarily rotating, turning or changing its orientation more than 90°, and thereby vary its point of engagement with any adjacent links to which it is interconnected, such that any impact, wear or stress upon the link due to interaction with the object or product being struck by the chain and with such adjacent links occurring during such flailing or debarking operations will be distributed over a range of impact or wear points along the inner and outer perimeter of the link. A “passing” link, preferably, will not have a u-shaped end, such as the lengthwise ends of an oblong link 34, 134 that, due to the close proximity of the respective sides of the u-shaped end, limits the frequency of any events during such flailing operations in which such a link will change its orientation relative to its adjacent links. It will be appreciated that “passing” links will have a generally curved inner perimeter, surrounding a central opening of the link that will be arcuate in at least two different regions of this inner perimeter that may or may not be separated by substantially straight inner perimeter surfaces. In the most preferred embodiments, the inner perimeter will be substantially round. Preferred passing links will include a substantially flattened portion on the outer perimeter opposite the weld section as to maintain and position proper orientation for welding the link as further discussed below. In various embodiments, passing links will be substantially round links so that they can be easily reoriented with respect to adjacent links with out being limited by any inner perimeter regions or portions where furthest opposing sides of the link are so close together that two links, each adjacent to a center link, are unable to slide along and pass one another within the inner perimeter of the center link. In preferred embodiments of the present debarking chain or flail chain, the radius of the turn along the inner perimeter or the inner boundary of any passing links will be large enough such that no regions of the link will have an opposing side that is closer than a length of 2 or more times the thickness or diameter D of the continuous strand of wire material that forms the adjacent links. For example, if the chain link is made of 0.50 inch diameter wire material having a substantially uniform diameter, as chain link wire material generally does, none of the respective portions of the continuous wire strand material will consist of a plurality of curved or arcuate portions and/or straight portions that are interconnected to form a chain link in which the radii of any portion of the inner perimeter of any of the arcuate portions are interconnected to form a chain link in which no two opposing sides of the link are spaced apart less than at about 2 times (1.00 in.) the diameter or thickness D of the continuous strand of wire material of which the chain link is formed. A passing link will necessarily allow adjacent chain links interlocked therewith to slide over one another or “pass” within the central cavity of the chain link. Such a chain link is therefore able to rotate relative to adjacent chain links. As a result, the orientation of the passing link with respect to the adjacent chain link can change easily during a flail or debarking operation so that the wear on the passing link, associated with its interaction with the object or product being struck, or with its adjacent or next to adjacent chain links that collide with the passing link, is distributed around the periphery of the passing link.

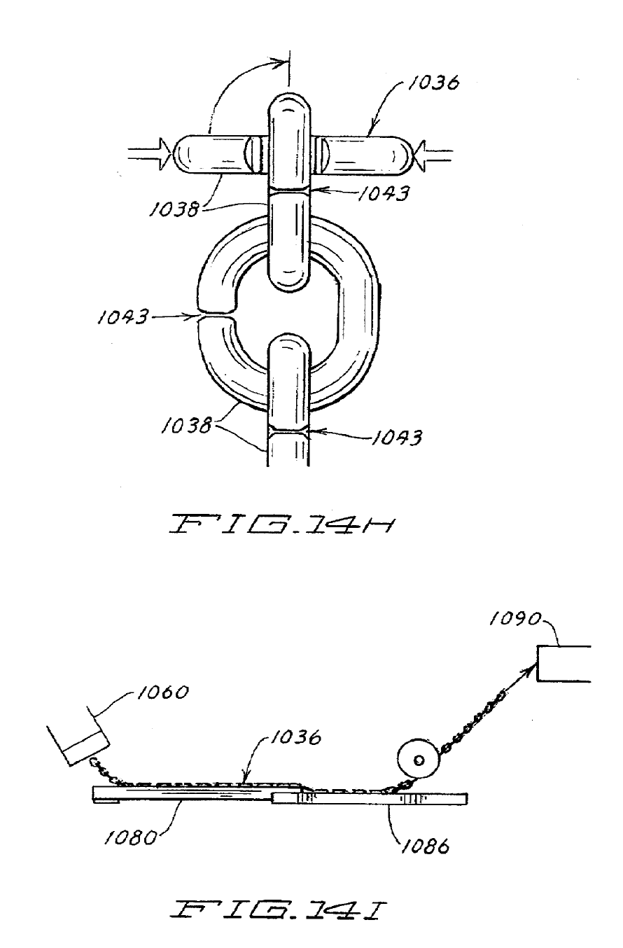

A preferred passing link 140 is illustrated in FIGS. 13A and 13B. The preferred passing link 140 is composed of a continuous strand 141 of wire material. The preferred passing link 140 includes first and second segments 142a, 142b. The first and second segments are generally divided by dashed line DL. The first segment 142a is substantially semi-circular and includes a weld section 144 and the second segment 142b includes a stabilizing portion 148 having at least two spaced apart contact points 148a, 148b on the outer perimeter 149b that can stabilize the link 140 on a flattened portion such that the link can slide or rest on the surface without rolling or changing its orientation to the surface. The stabilized portion 148 is preferably a substantially flat or substantially flattened portion 148 on the outer perimeter 149b opposite the weld section 144. In preferred embodiments, the substantially flattened portion 148 of the passing link has a length L1 that is less than about one-third of a length L2 of the respective passing link 140. In even more preferred embodiments, the length L1 of the flattened portion 148 is about 0.111 the length L2 of the respective passing link 140. In preferred embodiments, the length L1 of the substantially flattened portion 148, or between contact points 148a and 148b, is at least about equal to one diameter D of the wire material 141. The second segment 142b is also generally semi-circular and further includes two rounded ends 146c, 146d on each side of the substantially flattened portion 148, the two rounded ends being continuous with rounded ends 146a, 146b of the first segment 142a. The preferred passing link 140 further includes first and second rounded portions 146c, 146d on each side of the stabilizing portion 148, in this case the substantially flattened portion 148, each rounded portion extending continuously towards ends 146a, 146b and ultimately joined at the weld section 144.

It will be appreciated that when it is said that the weld section 144 is opposite or on the opposite side of the link 140 from the flattened portion 148 that the weld section and the substantially flattened portion 148 do not need to be directly opposite one another and that the weld section may be just within the turn radius of the opposite segment on the opposite side of the passing link from the substantially flattened portion. Furthermore, it will be appreciated that the substantially flattened portion 148 need only be substantially flat on the outer perimeter 149b of the link 140 and that the substantially flattened portion need only provide two points 148a, 148b that will act so as to cause the formed passing link, as shown in FIGS. 13A and 13B to slide without rolling on a flattened portion during the formation of the welded passing link, as the formed passing link or chain link blank 1056 seems to be both a link and a flail chain advances toward the welding machine where the weld is created. It will be further appreciated that the stabilizing portion 148 may in fact be somewhat inwardly arcuate or concave as long as there are two spaced apart points 148a, 148b in the second segment 142b that minimize the passing link from rolling when the two points 148a, 148b are in contact with a flattened portion on which the passing link is transferred. In preferred embodiments, the length or distance L1 of the flattened portion 148 or the length L1 between the two points 148a, 148b will be in the range of about one to about three times the diameter or thickness D of the continuous strand of wire material.

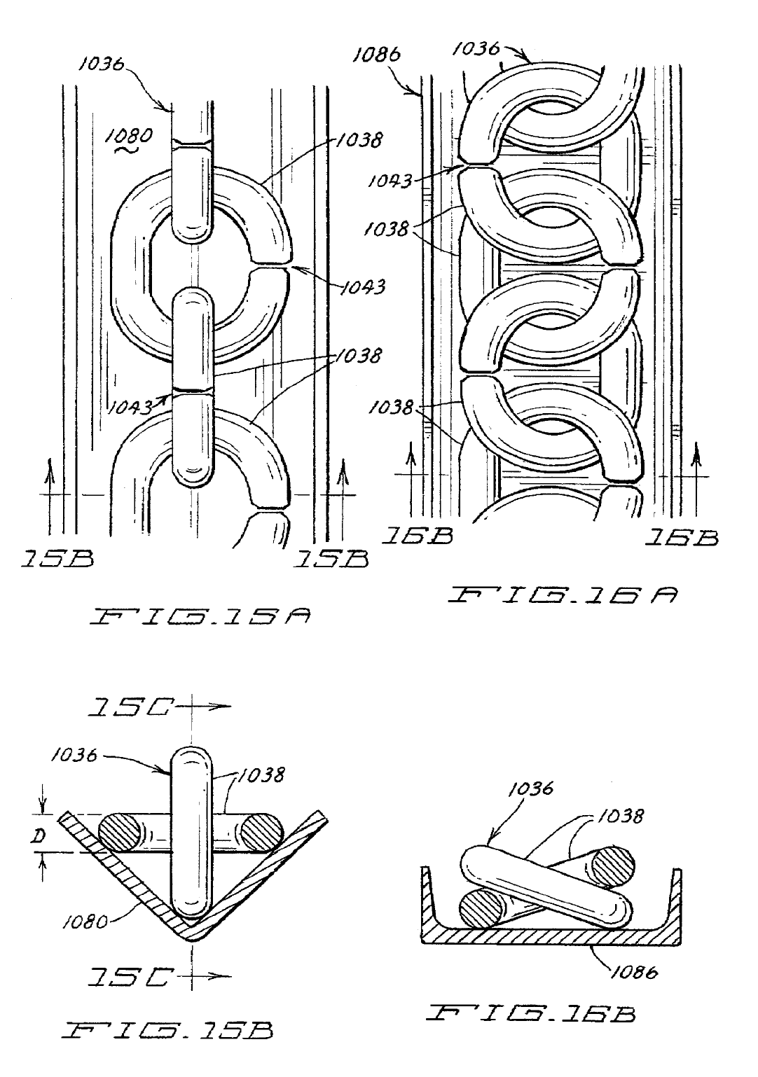

The preferred passing link 140 further includes a central opening 147 within which adjacent chain links can be interlocked and, preferably, rotate. The central opening 147 is defined by an inner perimeter 149a of the continuous strand 141. The central opening 147 has a height H and a width W. The height H is the shortest distance from the inner perimeter 149a proximate the substantially flattened portion 148 to the inner perimeter 149a proximate the weld section 144. Preferably, the shortest distance between the inner perimeter 149a proximate the weld section 144 to the inner perimeter 149a proximate the substantially flattened portion 148 is about equal to the shortest distance between the inner perimeter 149a proximate one rounded end or portion 146c of the second segment to the other rounded end or portion 146d of the second segment 142b. A preferred height would be from about 1.5 to about 2.0 inches. In one example the height will be 1.74 inches. The width W is the shortest distance from the inner perimeter 149a proximate one rounded end 146c to the inner perimeter proximate 149a the second rounded end 146d. A preferred width is from about 1.6 to about 2.1 inches, more preferably from about 1.7 to about 1.9 inches. Preferably, the passing links are arranged and configured such that an adjacent chain link having a diameter of at least about 0.656 inches can pass. Moreover, it is preferred that both the height H and width W are such that the radii of the turns along the inner perimeter of the passing links will be large enough that no regions of the passing link will have an opposing side that is closer than a length of at least two or more times the diameter or thickness D of the continuous strand of wire material that forms the passing link, as also discussed above. The thickness D of the continuous strand of wire material that forms one passing link is about 0.656 inch (see also, FIG. 15B). It will be understood that passing links 240, 340, 440, 540, 640, 740, 840, 940, 1040 and 1140 and flail chains 126, 226, 326, 426, 526, 626, 726, 826, 926, 1026 and 1126 discussed herein, are preferably constructed in a similar manner having similar features.

It will be appreciated that passing links can be made from elongated or oblong chain links welded steel, which are preferably made of carbon steel or other steel alloy, that are “bumped” or struck or pressed with sufficient force on at least two sides or on one side against a generally immovable object, in a manner that permits the shape of the passing link to become more rounded or arcuate on the surface of the inner perimeter of the passing link when the force is applied. In various preferred processes, the chain link will be “bumped” lengthwise simultaneously on opposite ends of a oblong chain link so that the long straight sides of the chain link will bend, creating a region along the inner perimeter of the chain link, proximate an area where the inner perimeter was previously straight, where this region is now bent or arcuate. This bumping step can be repeated or controlled until a desired degree of “roundness” is obtained. Alternatively, the chain link may be placed in a press, preferably a hydraulic press that will place sufficient force on opposite lengthwise ends of the oblong chain link to bend the straight sides into a proximately curved shape or in any event creating sufficient width to allow the chain link to rotate relative to adjacent chain links. Alternatively, a specialized press or “bumping” device that initially directs force to two opposing sides, but eventually directs force to a plurality of sides of such a chain link could be designed to produce more evenly rounded chain links that are most preferred. Alternatively, a chain link can be reshaped by forcing the chain link downward along an elongated device having an increasing diameter or dimension that can expand the distance between any two surfaces along the inner perimeter of the chain link, thereby creating a rounded or arcuate surface along a previously straight region of the inner perimeter. Alternatively, a debarking chain may be formed by taking a chain consisting entirely of passing links and “bumping” or reforming some of the passing links in order to make oblong chain links. These processes, however, are believed to be not the most cost effective.

Preferably, debarking or flail chains having passing links are manufactured by taking a straight continuous strand of link or wire material 141 and bending the straight continuous strand with bending tools of the bending or forming machine in intermediate forming steps until rounded ends of the continuous strand are touching opposite a substantially flattened portion such that a first chain link is partially formed. Next, a second continuous strand is fed to the bending tools where a second chain link is formed with the same process such that it interlocks the first chain link. The process is repeated until a continuous, unwelded flail chain of the desired length is completed. Then, the process is completed with a welding and de-burring step in which the flail chain is fed through welding and de-burring operations.

The inventors have discovered that a passing link can be configured such that the chain link includes a continuous strand of material 141 including a substantially flattened portion 148 opposite a weld section 144, thus essentially eliminating link rolling and providing properly positioned gaps 143 necessary for welding in the continuous resistance upset welding process. The substantially flattened portion 148 is on the outer perimeter 149b of the continuous strand 141. The length L of the outer perimeter of the flattened portion 148 is preferably sized such that the passing link 140 will generally not roll if supported on a substantially flattened portion as it is moved to the individual link welding machine. Length L may be in the range of about one to about three times the thickness or diameter of the continuous strand 141. The flattened portion or surface 148 is further preferably sized such that the flattened portion 148 is as short as possible as to generally maintain the generally round, “passing” quality of the passing link 140. For example, the length L of the flattened portion 148 with respect to the outer perimeter 149b is preferably less than 33% of the total length of the outer perimeter, even more preferably less than 20%, even more preferably less than about 8%. For example, a preferred passing link 140 is configured such that the inside perimeter is about 5.54 inches and the outside perimeter is 9.61 inches, wherein the substantially flattened portion on the outer perimeter 149b has a length L of about 0.80 inches, thus resulting in length L being 8.3% of the outer perimeter 149b. Preferably, length L is in the range of about one to about three times the thickness or diameter of the continuous strand 141.

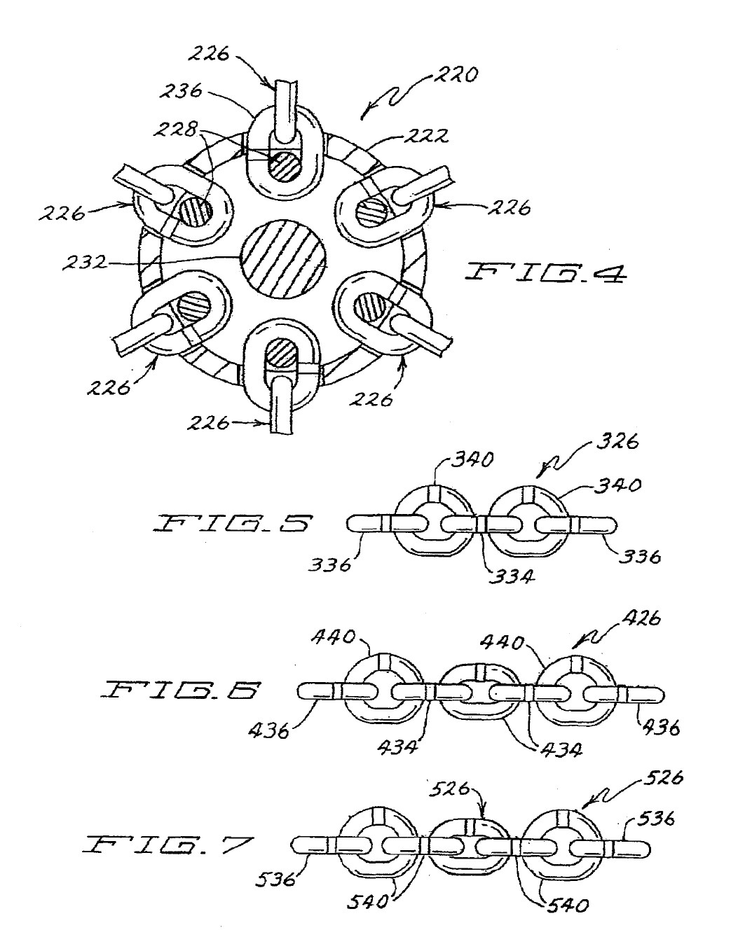

It will appreciated that it is believed to be most cost effective to make flail chains by this method that solely include passing links of a uniform shape as illustrated in FIGS. 11B and 11C. It is believed that such a debarking or flail chain 1026 will be more difficult to use with present technology as designed by the debarking drum manufacturer, because the debarking drums, which are in current use and/or production, generally require end links that are oblong in order to be received in the “pocket” and secured to the drum (see also, FIGS. 3-4). Such pockets 224 typically may be manually modified to increase the size of the pocket opening to accept debarking chains of the present invention. It is envisioned that debarking drums will either be equipped with a securing device that will connect with debarking chains outside of the “pocket” or the “pockets” will be enlarged so that they will be able to receive a passing link as may be present at the end of a debarking chain of the present invention.

The earliest passing links manufactured by the inventors were formed from typical oblong chain links that were mechanically deformed into a passing link condition such that they were somewhat round. In inventors, through studies and experimentation, discovered that these chain links were generally square shaped and had higher wear patterns near the corners of the somewhat square link. Moreover, it was found that mechanically deforming oblong chain links is labor intensive and generally cost prohibitive.

The inventors then considered how a chain including all generally round passing links could be made with automatic processes. Current automatic processes typically include a welding step in which interlocked, formed or bended continuous strands are joined into continuous chain links by mechanically feeding each chain link of the flail chain to the welding device so that each chain link can be individually welded. It was found, through study and experimentation, that generally round links would roll and move out of position during the transfer from the forming machine to the welding machine 1090, thus resulting in inaccurate alignment of the respective chain link 1040 relative to the welding electrodes 1096a, 1096b.

The inventors then considered potential ways of designing a passing link such that it would not roll during the transfer from the forming machine to the welding machine. The inventors found, through study and experimentation, that if the passing link included a short, substantially flattened portion on the outer perimeter of the passing link opposite the weld section, the passing link would generally not roll and would remain in position during the feed process and as it is presented to the welding electrodes 1096a, 1096b. It was found that a 0.656 inch diameter continuous strand having a length of 7.7 inches and having a 0.80 inch substantially flattened portion (measured from the outer perimeter L) on a Wafios Machinenfabrik GmbH & Co. chain bending machine model no. KEB 7 with a Wafios Machinenfabrik GmbH & Co. welder and de-burring machine model no. KEH 7 resulted in effective continuous resistance upset welding and is preferred.

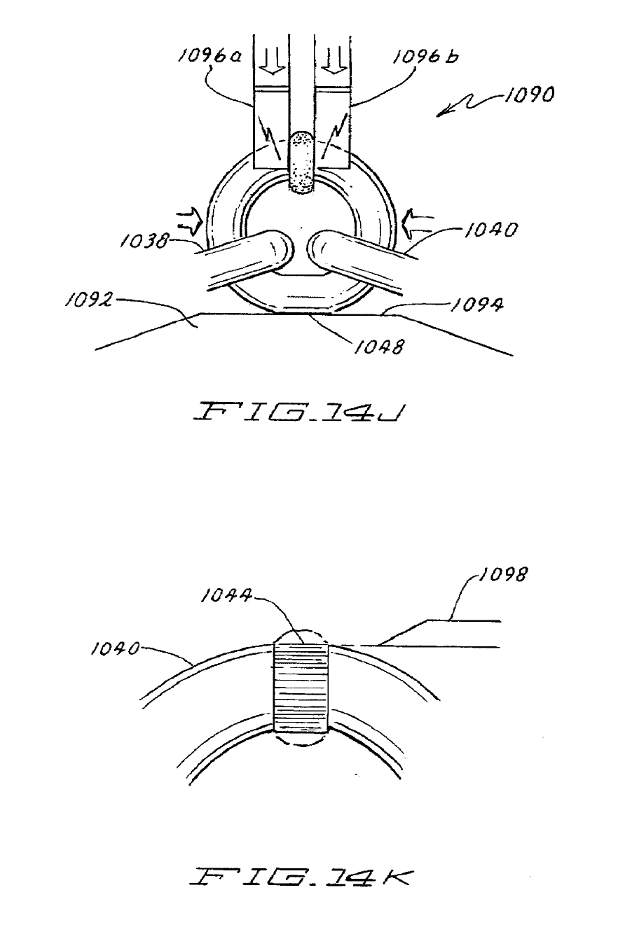

The substantially flattened portion 148 includes at least two points, preferably opposite from and symmetrical to gaps 143 of a formed but not yet welded link (see, in particular, FIG. 13A). The substantially flat portion would therefore define and create a stabilizing feature to prevent the formed passing link from rolling when in contact with passing link transport and positioning surfaces after forming and associated with the welding machine. The substantially flat portion generally insures proper orientation of the interlocking formed passing links as they are individually and continuously advanced to the welding machine and the gaps 143 of the formed link is presented to, and positioned for, the welding electrodes 1096a, 1096b (see also, FIG. 14J). A more perfectly round passing link without the substantially flat portion may be more desirable in terms of distributing impact and the resulting wear during debarking, thus extending the wear life of the flail chain. Such a round passing link, however, could not be cost effectively manufactured due to an inability to maintain proper orientation of the formed passing link for accurate and effective continuous resistance upset welding.

Referring now also to FIGS. 14A-14K, preferred methods of manufacturing a flail chain of the present invention include first providing a bulk length of wire material 1050 having a lead end 1051. The lead end 1051 is fed into a wire forming machine 1060 through straightening rollers 1062 (see, FIG. 14A). A plurality of chain link blanks 1056 are created in series by separating the chain link blanks 1056 from a portion 1052 of the bulk length of wire material 1050 in a repeated fashion. The chain link blank 1056 is created in the bending machine 1060, after two notches 1054a, 1054b are created on opposite sides of the wire material 1052 by two notch blocks or notcher dies 1064a, 1064b as is generally shown in FIG. 14B. The notcher blades 1064a, 1064b place a series of notches 1054a, 1054b on opposing sides of the wire so that a series of chain link blanks 1056 can be created in series as left and right arms of a U-die 1066a, 2066b strike the lead end 1051 to separate the chain link blank 1056 from the wire portion 1052 and bend it around a bending mandrel 1068. It will be understood that other dies can be used as desired.

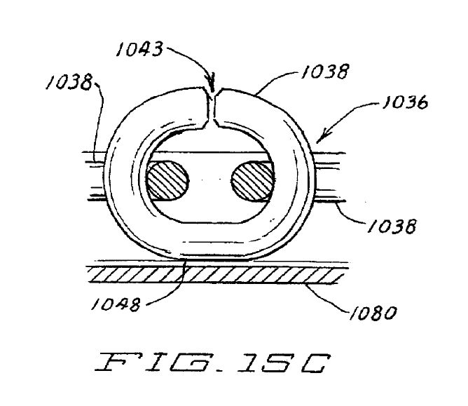

The portion of wire material 1052 is separated at the notches 1054a, 1054b to divide a chain link blank 1056 from the portion of wire material 1052 (see, FIG. 14C). In practice, a series of chain link blanks 1056 are formed by separating away a portion of wire marital proximate a lead end 1051 of the bulk length of wire material 1050, when the lead end 1051 is punched by two arms of a u-shaped die 1066a, 1066b of the bending machine 1060. The chain link blank 1056 has two end portions 1057 that are initially bent at least partially around a forming mandrel 1068 and can be further formed as to create a plurality of interlocking unwelded formed links 1038 in a series of different bending steps as generally illustrated in the drawings (see, FIGS. 13A and 14C-14H). Preferably, each unwelded formed link 1038 is a substantially identical to a preferred passing link 1040 (see also, FIG. 13B), except that the gap is unwelded. After a number of unwelded formed links 1038 have been formed, a resulting chain of unwelded formed links 1036 can be transported to a welding machine 1090. In preferred embodiments, the chain of formed chain links 1036 is transported at least partially in a generally V-shaped channel or bar 1080 that leads in the direction of the welding machine 1090 (see, for example, FIGS. 15A-15C). The generally V-shaped channel 1080 supports and aligns the stabilizing portion or generally flattened portion 1048 of the individual unwelded formed links 1038 such that the chain links generally do not roll as they are being transported. In further preferred embodiments, the chain of unwelded formed links 1036 is under tension to further prevent the respective links from potentially rotating during transport. An alternative, rectangular channel 1086 is illustrated in FIGS. 16A-16B. Such a rectangular channel 1086 may be used if the chain of formed link 1036 has previously oriented and is under tension or could be reoriented to be used to maintain the orientation of the respective unwelded formed links 1036.

Once the formed links 1036 are fed into the welding machine 1090, each respective gap section 1043, between ends 1057 of each chain link blank 1056, is then welded by resistance upset welding. During welding, the respective unwelded formed link 1038 is positioned such that the generally flattened portion 1048 sits on a longitudinally flat surface or base 1094 of saddle or block 1092 of the welding machine as the respective gap section 1043 is being welded together to close the gap 1043. The generally flattened portion 1048 ensures more accurate and continuous welding by preventing the unwelded formed link 1038 from rolling during transport from the forming/bending machine 1060 to the welding machine 1090 and as the unwelded formed link 1038 is ultimately positioned for welding on base 1094. After welding, weld section 1044 can be trimmed or deburred as desired with at least one trimmer 1098 as commonly practiced in the art (see, schematic FIG. 14K).

Since debarking drums, in the early stages of development of this invention, included pockets that were not sized for receiving passing links of the present invention, the inventors provided oblong end links to chains including passing links including substantially flattened portions (one oblong chain link on each end of the chain such that the chain can be flipped and the other end of the chain can also be connected to the debarking drum). Such flail chains were tested for effectiveness and wear life and it was found that the effectiveness for removing bark and delimbing was adequate to meet the specifications for bark content in the chips that were produced, however, it was observed that the oblong end links had a wear life similar to that of end links of flail chains that include all oblong chain links. Therefore, although the passing links had a longer useful life than the end links, the flail chains still had to be replaced at approximately the same time as known chains because of end link wear.

It is therefore preferred that the flail chains include chain links that are all passing links. It is envisioned that debarking drum manufacturers will soon configure their debarking drum pockets to accommodate such debarking chains in view of the inventors' findings and the anticipated demand for flail chains of the present inventions. The inventors' have found, after study and experimentation, that flail chains including all passing links outlast known flail chains including non-passing or oblong chain links and that such flail chains can be cost effectively manufactured in accordance with the teachings herein.

It is believed that the present invention enables users of the preferred debarking or flail chains to expect an increase in the wear life of the chain links of at least about 30%. The substantially round passing links 140, 240, 340, 440, 540, 640, 740, 840, 940, 1040, 1140 can randomly pass through adjacent chain links, turning its orientation with respect to such adjacent chain links thereby randomly changing the wear or impact point where the respective adjacent or next to adjacent chain links engage the passing link during repeated flailing events or operations. The wear or impact points will generally be randomly distributed around the inner and outer perimeter of the passing link. The result of such generally random turning or reorientation of the passing link with respect to adjacent links will preferably be a more evenly distributed wear of the passing links, thereby extending flail chain wear life as compared to standard flail chains consisting of elongated oblong chain links.

As noted above, the preferred debarking apparatus 110 of the present invention incorporates debarking chains 126, each having one or more passing links 140 is illustrated in FIG. 2. The debarking/delimbing apparatus 110 preferably includes one or more upper and one or more lower debarking drums 120a and 120b, respectively. In various embodiments, each debarking drum 120a and 120b, includes multiple debarking chains 126 possibly including both elongated or oblong chain links 134 and passing links 140, which are used to flail the surface of a log 112 to remove bark and small limbs (not shown). Also included in preferred embodiments is an adjacent wood chipper 150, located behind the debarking drums 120a and 120b. In one preferred embodiment of the present invention, the wood chipper 150 is located close enough to the upper debarking drum 120a such that debris from a failed chain or chain link could enter the wood chipper 150, causing costly damage and machine downtime. Although it is common practice to replace debarking chains 126 prior to the end of their expected, projected or observed wear life, the expected wear life may be extended by incorporating passing links, thereby realizing a cost savings associated with less equipment down time and more chips per flipping or change-out of debarking chains.

The embodiment of the present invention shown in FIG. 2 includes passing links 140 to reside at any point within any debarking chain 126. In certain embodiments, end links 136 can be used to connect the respective debarking chain 126 to the remaining portion of respective debarking drum 120a, 120b. At the connecting end of each debarking chain 126, an elongated chain link 134 is generally required, for most existing debarking devices, in order to allow the end link 136 to fit within a pocket 224 of the type shown in FIG. 3 that are commonly provided in existing prior art drum cylinders 222 like that shown in FIG. 3.

FIG. 3 illustrates an alternate debarking drum assembly 220 of the present invention. The debarking drum 220 has an outer surface or cylindrical plate 222 having a plurality of chain securing openings or pockets 224 in which an end link 236 can be secured. The debarking drum assembly 220 is configured to allow the end links 236 of the debarking chains 226 to fit into the pockets 224, along an axis perpendicular to the length of the debarking drum assembly 220. The end link 236 of each debarking chain 226 that resides within the pocket 224 is secured by a securing rod 228 that is preferably configured to slide through securing openings 229 in hubs 230 at each of two ends of the cylindrical plate 222 or perhaps at a single end in other embodiments, such that it can reside within the cylindrical plate 222 of the debarking drum 220 along an axis parallel to that of the debarking drum 220 and inserted such that it passes through the end link 236 each of the attached debarking chains 226. Each debarking chain 226 in the debarking drum assembly 220 is preferably constructed to rotate about the axis defined by shaft 232 at a high rate of speed.

A cutaway view from the illustration shown in FIG. 3 is shown in FIG. 4 showing the debarking drum assembly 220 in greater detail. The end link 236 of each debarking chain 226 that passes through the openings or pockets 224 is preferably fastened to a rod 228 secured between hubs 230 at each end of the drum assembly 220.

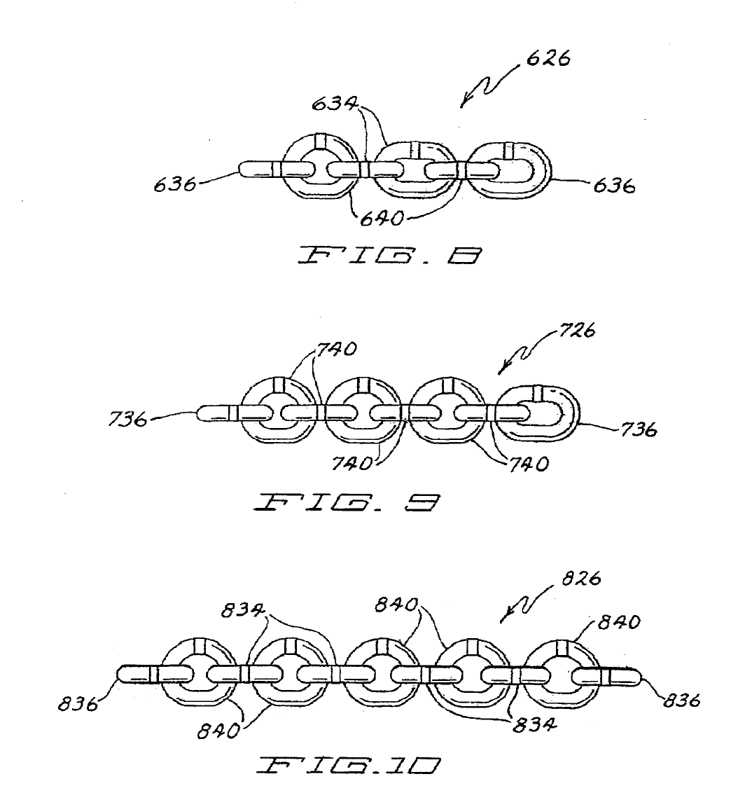

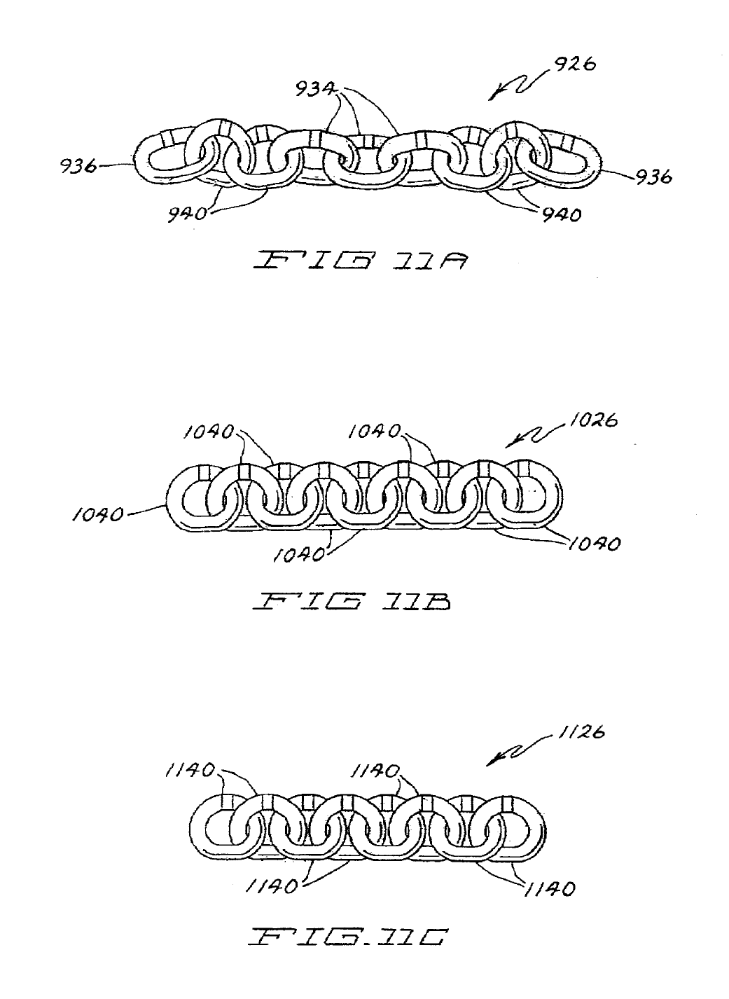

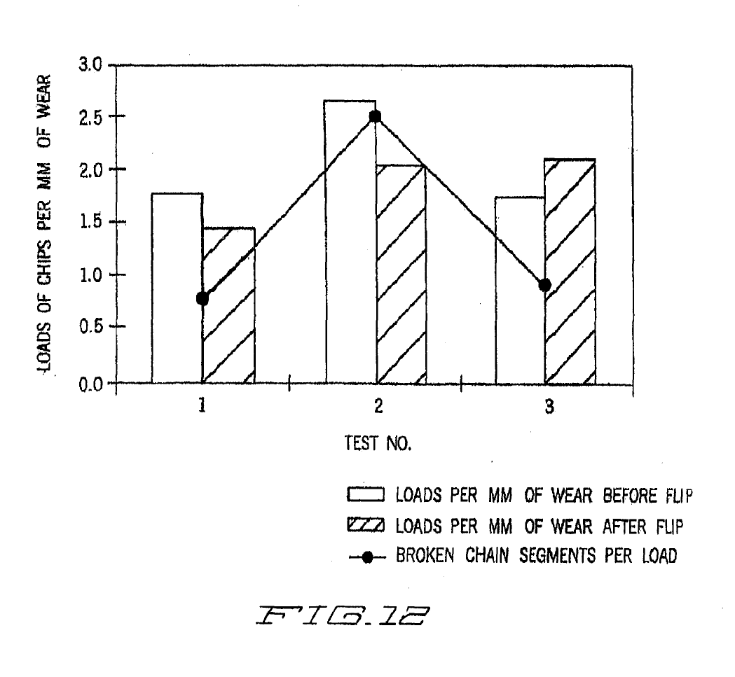

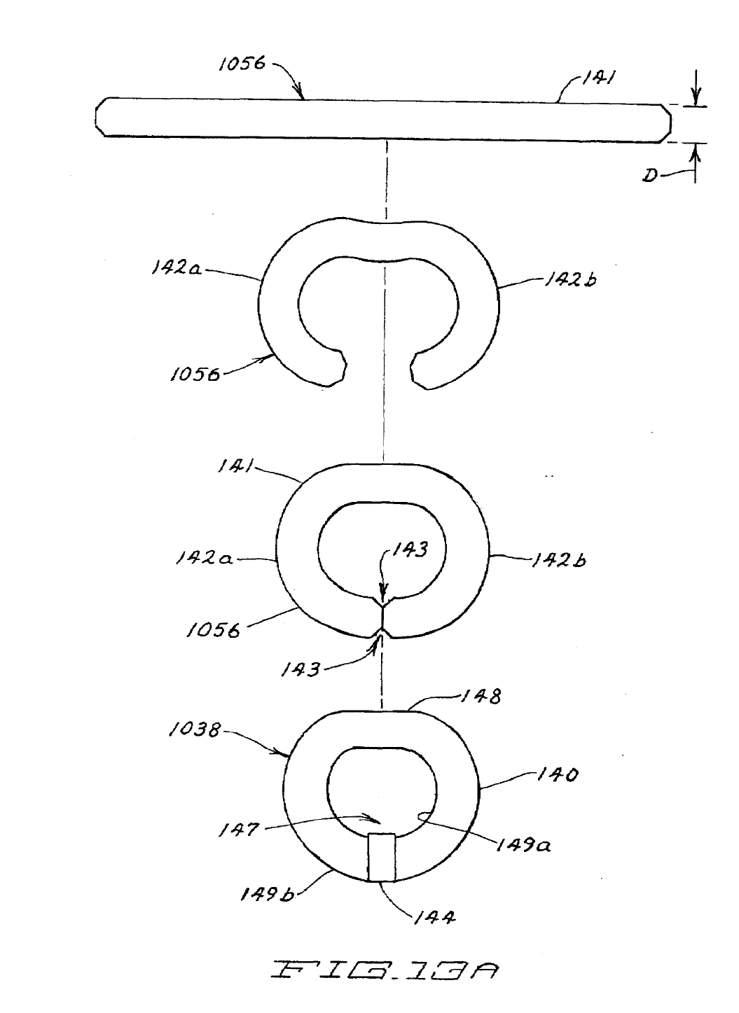

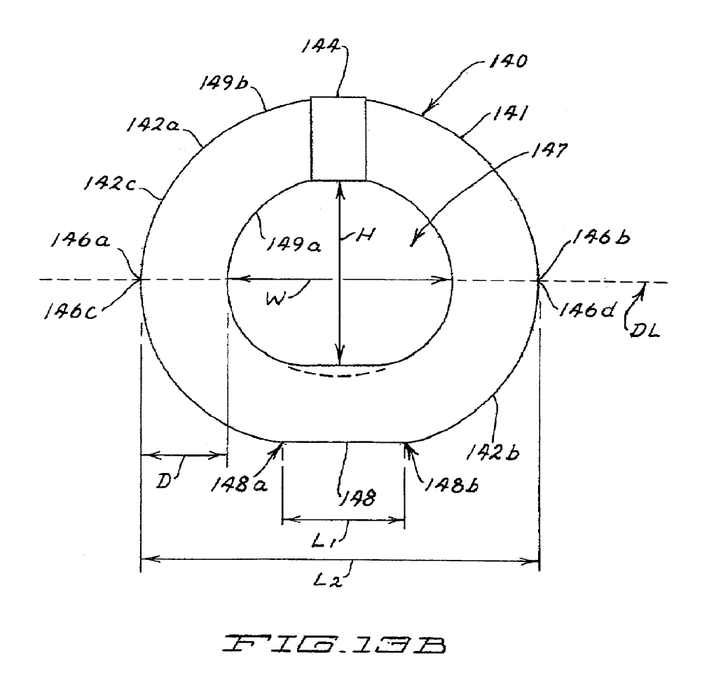

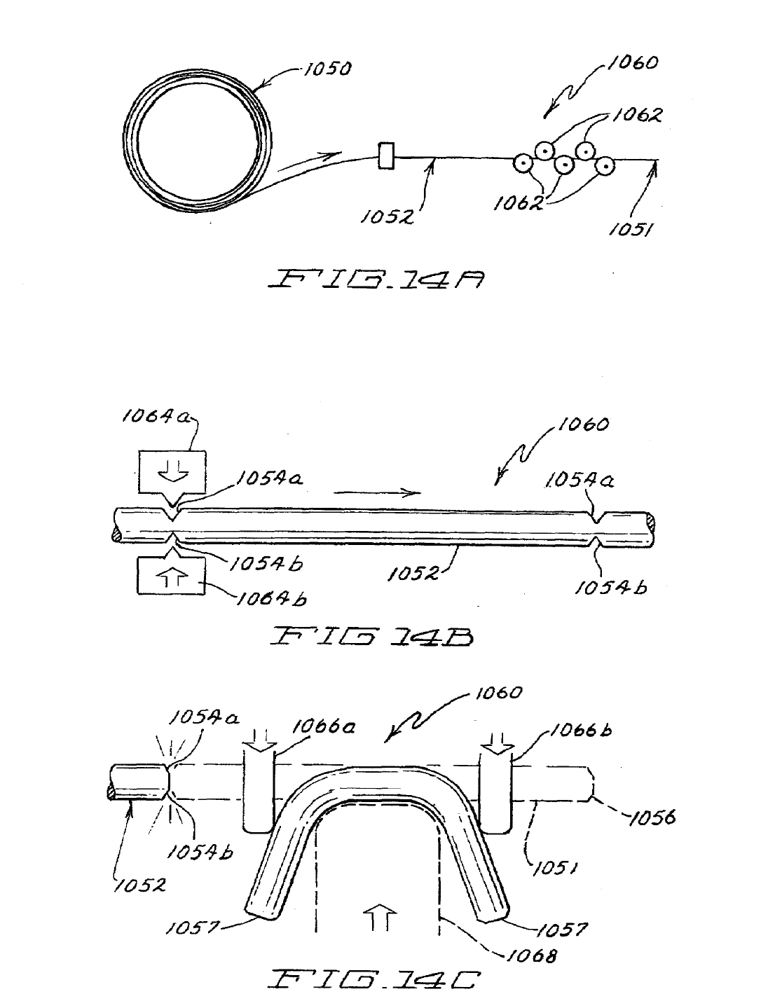

Many embodiments of alternate debarking chain configurations are illustrated in FIGS. 2-11B. In FIG. 2, the debarking chains 126 each have seven chain links, five of which are passing links 140 and two of which, namely the end links 136, are elongated oblong links 134 that are elongated and narrower than the passing links 140. In FIGS. 3 and 4, an alternate debarking or flail chain 226 is shown each having eight chain links, only one of which is a passing link 240 and seven of which are oblong links 246, 236. FIG. 5 illustrates an embodiment of the present debarking or flail chain 326 having five chain links, two of which adjacent to each end link 336 are passing links 340 and three of which are oblong links 334, 336. FIG. 6 illustrates an embodiment of the present debarking or flail chain 426 having seven chain links, two of which, the second chain link from the end on each side, are passing links 440 and five of which are oblong links 434, 436. FIG. 7 illustrates an embodiment of the present debarking or flail chain 526 having seven chain links, four of which, the second and third chain links from each end, are passing links 540 and three of which are oblong links 534, 536. FIG. 8 illustrates an embodiment of the present debarking or flail chain 626 having six chain links, two of which, the second links from each end, are passing links 640 and four of which are oblong links 634, 636. FIG. 9 illustrates a further embodiment of the present debarking or flail chain 726 having eight chain links, six of which, each of the chain links between the end links 736, are passing links 740. FIG. 10 illustrates yet another embodiment of the present debarking or flail chain 826 having eleven chain links, five of which, every other chain link after either of the end links 836, are passing links 840 and six of which are oblong links 834, 836. FIG. 11A illustrates a further alternate embodiment of the debarking or flail chain 926 of the present invention that was prepared for testing purposes in the tests that are reported below in Example I. This flail chain 926 has nine chain links, four of which are passing links 940 and five of which are oblong links 934, 936. Passing links 940 are the second and third chain link in from each of the two end links 936.

As previously discussed, it will be appreciated that various debarking chains will have an oblong chain link 134 in both end positions to accommodate the limitations of existing debarking drum devices that have pockets for securing such chains that generally require an oblong chain link 134. Any or all of the chain links may be passing links, however. In alternate embodiments, the debarking chains of the present invention can have as many as five, six, seven, eight, nine, ten, eleven, twelve, thirteen, fourteen or fifteen chain links. In alternate embodiments, passing links may be used to connect the debarking chain to in debarking drums that may be plausibly developed to accommodate the debarking chain with passing links on both ends. Such a debarking or flail chain 1026, 1126, in which all of the chain links are passing links 1040, 1140 is shown in FIGS. 11B and 11C.

Various flail chain embodiments are heat treated for increased wear life. There are many known ways in which chain material can be heat treated to achieve properties suitable for a specific purpose or intended use.

As will become apparent to those skilled in the art, there are numerous variations in the configuration of the debarking or flail chains containing at least one passing link which is within the spirit and scope of the present invention. The length of the chains, number and location of passing links and oblong chain links are by no means limited to the configurations described herein. Additionally, different arrangements and organization of the various components are also possible.

One preferred method of manufacturing a flail chain 1040 includes the steps of first providing a bulk length of wire 1050 material having a lead end 1051. The lead end 1051 is then fed into a wire forming machine. The method further includes creating a plurality of chain link blanks 1056 in series by separating away a portion of wire material 1052 proximate the lead end 1051 of the length of wire material 1050 to create the respective chain link blanks 1056, each of which has respective first and second ends 1057. The plurality of chain link blanks 1056 are then consecutively bent into unwelded formed links 1038 in series such that the respective first and second ends 1057 of each chain link blank 1056 are turned toward one another and there is a gap 1043 between the respective ends 1057 on one side of each of the respective unwelded formed links 1038 and a stabilizing portion 1048 on an outer perimeter of each of the respective unwelded formed links 1038 on the side opposite the gap 1043; wherein the step of consecutively bending each of the chain link blanks 1056 includes creating an unwelded chain 1036 including a plurality of interlocking unwelded formed links 1038 from the consecutively bent plurality of chain link blanks 1056. The stabilizing portion 1048 preferably includes at least two spaced apart contact points 148a, 148b on the outer perimeter that can stabilize the respective unwelded formed link 1038 on a flat surface such that the respective unwelded formed link 1038 can slide and rest on the flat surface without rolling or changing its orientation relative to such flat surface. The method further includes creating a series of flail chains 1036 each including a plurality of interlocking, welded passing links 1040 by transporting the unwelded chain 1036 to a welding machine 1090 where the gap 1043 of each of the plurality of interlocking unwelded formed links 1038 is welded in series such that each of the respective unwelded formed links 1038 becomes a welded passing link 140, 1040 having first and second segments 142a, 142b and outer and inner perimeters 149a, 149b, wherein the first segment 142a is generally semi-circular and includes a weld section 144 and the second segment 142b includes a stabilizing portion 148 on the outer perimeter 149b opposite the welded section 144. The first segment 142a includes rounded portions 146a, 146b on each side of the welded section 144 having curved inner and outer perimeters 149a, 149b and the second segment 142b further includes two rounded ends 146c, 146d on each side of the stabilizing portion 148, the two rounded ends 146c, 146d being continuous with the first segment 142a and the stabilizing portion 148 including at least two spaced apart contact points 148a, 148b on the outer perimeter 149b that can stabilize the link 140 on a flat surface such that the link can slide and rest on the surface without rolling or changing its orientation relative to such flat surface. A welding machine 1090 is provided and the welding machine includes a welding block 1092 having a longitudinal surface 1094 that is generally flat. The step of creating includes a step of welding wherein each of the respective unwelded formed links 1038 are consecutively transported onto the longitudinal surface 1094 of the welding block 1092 so as to stabilize each of the respective unwelded formed links during the welding step such that the respective gaps 1043 are consecutively welded and a series of interlocking, welded passing links 140, 1040 are created; and wherein, following the step of welding, the step of creating further preferably includes a step of cutting wherein a series of the interlocking, welded passing links 140, 1040 are cut to enable a series of flail chains 1026, 1126 to be separated from the series of interlocking, welded passing links 140, 1040 created during the welding step.

It will be further understood that the debarking or flail chains of the present invention can be used for numerous flailing operations and are not limited to debarking operations. Such other uses or applications, include, but are not limited to quarrying, soil treatment, demining, and processing, cleaning or removing debris.

### Example I

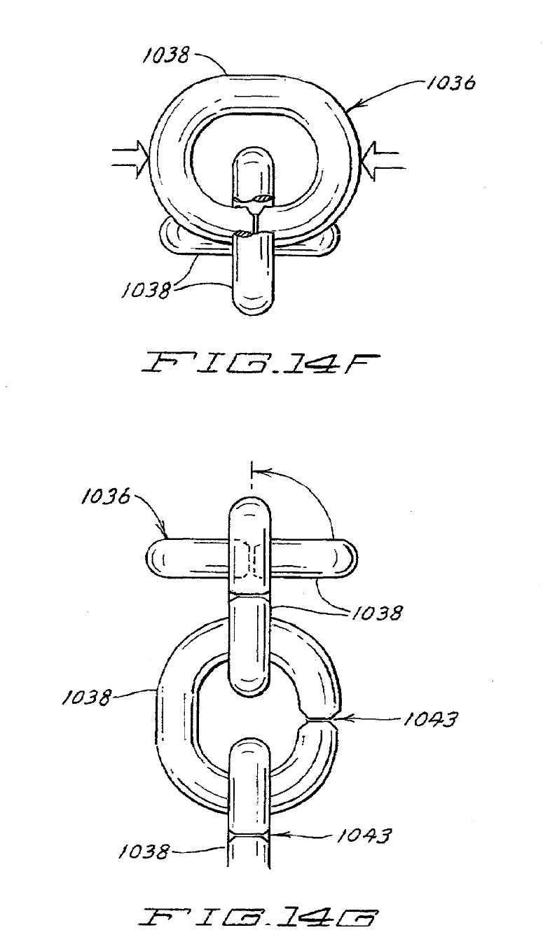

Referring now also to FIG. 12, in which testing results are displayed graphically, three types of debarking chain were tested at a debarking/chipping facility placing the experimental debarking chains test on the lower flail drum of a Petersen Pacific Debarker Chipper. The types of debarking chain tested were:

Test No. 1—Belt furnace heat treated debarking chains having eight 0.656 inch strand diameter chain links with an increased Rockwell hardness.

Test No. 2—Induction furnace heat treated debarking chains having eight 0.656 inch strand diameter chain links. The induction furnace heat treated chain links are believed to have hard ends and softer sides in contrast to the more uniform hardness along the periphery of the link for the belt furnace heat treated links used in Test No. 1.

Test No. 3—Prototypes of the debarking chain of the present invention having passing links as the second and third links from each end of 9-link (0.656 inch strand diameter links) debarking chains. Each of the passing links were bumped in a Piranha Punch (Model: SEPP 35 Punch 35 ton hydraulic press from Piranha, Hutchinson, Kans.) to round the straight sides of the chain links so that the chain links became substantially rounded. The intent is to allow these passing links to rotate, thus distributing the impact point such that the typical high wear areas at each end of the second chain link and at the base (radius closest to the log) of the third link will be minimized.

All chain types resulted in more loads per change-out of lower front flail drum debarking chain than was typical for the test site. The number of loads achieved were 13, 14 and 14 for Tests No. 1, No. 2, and No. 3 respectively. (typical performance was to achieve 12 loads—6 loads before flipping the chain end for end and 6 loads after flipping).

### Test Results

Test No. 1 chains performed well, even though it was clear to all parties present that, due to the way logs were loaded into the debarker/chipper, the chains on the far left of the flail drum (when viewed from the end of the machine where the logs were fed) experienced excessive wear. This forced the chains to be flipped well before the average wear would have required it had the logs been fed in a more balanced fashion. The chain experienced more even wear across the full width of the flail drum for all subsequent testing after these first six loads.

Test No. 2 chains performed very well in terms of wear, however, they also had the highest number of chain segments with broken and missing links.

Test No. 3 chains performed very well. These chains had the most number of loads after flipping and the only reason they were replaced after 14 loads is because they had “grown” or expanded in length to the point that they were beginning to strike the housing of the flail drum (debarking chains lengthen as interlink wear occurs). Operators, on-site supervisors and key management personnel were very impressed with the prototype Test No. 3 chain. The results indicated that the inclusion of passing links extend the usable wear life of the debarking chain by distributing the impact points, thereby eliminating the localized areas of wear.

### Methods

A Peterson Pacific Model 5000g debarking/chipping machine was used in the testing. A test of further prototypes will follow in which debarking chain similar to that in Test No. 3, will be tested but having only eight chain links rather than nine with the second and third chain links from each end bumped into a passing link configuration. The intent is to start a bit shorter so “growth” does not force the chains to be changed out. Additional testing will be conducted with the experimental chain on all three flail drums (we had chosen the worst case scenario, lower front flail drum, as the first test platform).

It is projected that an average increase of one load of chips being produced before and after flipping the chains at a debarking/chipping operation having nine in-field debarking/chipping machines, would, at the time of the test, result in an annual savings in the cost of debarking chain of about $350,000. Achieving two more loads before and two more loads after flipping was projected to result in a $700,000 savings. It is suggested that this estimate is conservative because it does not take into account the down time and additional labor associated with changing out the debarking chain. Clearly, improving the performance of debarking chain is an important matter for debarking chain users. At the time of the testing, the monthly cost of operating one debarking/chipping machine, in the winter in a northern North American environment was estimated to be about $26,000 for debarking chain and $23,000 for fuel.

Other pertinent information:
Logs being chipped were mainly aspen, some Russian poplar. The logs were frozen. Aspen and Russian Poplar are considered a hardwood.
The diameter at the base of the logs ranged from 5″ to 21″. The average diameter was about 8-10 inches.
Each load was 40 to 41 metric tons of chips.
High wear chains were moved to low wear areas of the flail drum and low wear chains were moved to high wear areas when the chain is flipped.
The bark content was measured for each load and reported back to the foreman of the debarking operations. The quality of the chips achieved during testing, averaging less than 1% bark content, was within specification.
The lower front flail drum was rotating at 637 rpm.
If all goes as anticipated in any test sequence, it takes 1 to 1½ hours to fill a 2-trailer load.
The debarking operation operates in 2 twelve hour shifts, typically 6 days a week.
Other debarking chain currently being used is Campbell, Rud (made in Brazil) and Honnetaler. The Honnetaler chain was produced at Vistec Chain Company in the Ukraine.
It became clear that the closer the passing links are to being truly round, the longer the wear. The prototype passing links were somewhat square, which limited the freedom to rotate and reduced the benefit of rotating.

The following data in Table 1, below, provides a relative indicator of the performance of debarking chain expressed in terms of the number of loads per millimeter of wear. Wear is determined by subtracting the average smallest diameter of the 2nd link from an original diameter of 0.656 inches. Also shown is the number of broken segments of debarking chain per load. This data is also shown graphically in FIG. 12.

It is noted with respect to Test No. 1, that the loads per millimeter of wear before the chains were flipped was negatively influenced due to excessive wear occurring on debarking chain segments on the left side (as viewed from the front of the debarking machine). This excessive wear of chains on the left side of the flail drum forced the flipping decision and is associated with the way logs were loaded into the machine. Since chains that were in the middle and on the right side of the flail drum were minimally worn, the average smallest diameter of the second chain link is overstated. If the logs were loaded in a more balanced fashion, the average smallest diameter of the second chain link would have been lower (that is, the average wear would have been higher), and more loads would have been achieved before flipping.

TABLE NO. 1
DEBARKING CHAIN PERFORMANCE EXPRESSED IN TERMS
OF LOADS PER MILLIMETER OF WEAR AND BROKEN CHAIN
SEGMENTS PER LOAD

| | TEST NO. | | |
|---|---|---|---|
| | 1 | 2 | 3 |
| CHAIN TYPE | 0.656 × 8 BELT FURNACE | 0.656 × 8 | 0.656 × 9 WITH |
| | HIGHER ROCKWELL | INDUCTION HEAT | PASSING LINKS |
| | HARDNESS | TREAT | |
| NO. BEFORE FLIP LOADS | 6 | 7 | 6 |
| NO. AFTER FLIP LOADS | 7 | 7 | 8 |
| BEFORE FLIP AVG 2ND LINK | 0.522 | 0.552 | 0.520 |
| SMALLEST DIAMETER | | | |
| (INCHES) | | | |
| AFTER FLIP AVG 2ND LINK | 0.466 | 0.521 | 0.506 |
| SMALLEST DIAMETER | | | |
| (INCHES) | | | |
| BEFORE FLIP AVG 2ND LINK | 3.40 | 2.64 | 3.45 |
| WEAR (MM) | | | |
| AFTER FLIP AVG 2ND LINK | 4.83 | 3.43 | 3.81 |
| WEAR (MM) | | | |
| NO. OF CHAIN SEGMENTS | 10 | 35 | 13 |
| WITH BROKEN OR MISSING | | | |
| LINKS | | | |
| BEFORE FLIP LOADS PER | 1.8 | 2.6 | 1.7 |
| MM OF WEAR | | | |
| AFTER FLIP LOADS PER MM | 1.5 | 2.0 | 2.1 |
| OF WEAR | | | |
| BROKEN CHAIN SEGMENTS | 0.77 | 2.50 | 0.93 |
| PER LOAD | | | |

### Example II

An independent study was conducted by Daishowa-Marbubeni International in Peace River, Alberta, Canada in which the debarking chain 1026, as generally shown in FIG. 11C, having 8 interlocking passing links 140, 1040, each having a substantially flat portion 148, was compared to a competitor's standard oblong flail chain having eight oblong links as are currently standard in the industry. The tested flail chains were attached to the upper flail drum. The study compared the average number of loads produced before the respective flail chains were flipped, and then subsequently worn to the point where it was believed that they had to be replaced because the risk of link breakage. The decision to flip or replace the chain is typically made when the smallest diameter of any link at the free or working end of the chain is about 60% or less of the original wire diameter. If the chain has not been flipped, the chain will be flipped at that time. If the chain had previously been flipped, the chain will then be replaced. The results of the study are indicated below in Table No. 2. It is noted that a flail chain having links as illustrated in FIGS. 11C and 13A debarked approximately 95% more loads than a flail chain having standard, oblong links. Such an improvement is significant as the frequency of flail chain replacement due to premature fracture or loss has a significant impact on the cost of chain per ton of chips.

TABLE NO. 2

| | LOADS | LOADS | |
|---|---|---|---|
| | BEFORE | AFTER | TOTAL |
| TIMEFRAME | FLIP | FLIP | LOADS |
| MONTH ONE STANDARD | 4.1 | 8.1 | 12.2 |
| LINK CHAIN | | | |
| MONTH TWO STANDARD | 4.6 | 7.8 | 12.3 |
| LINK CHAIN | | | |
| MONTH TWO PASSING LINK CHAIN | 9.2 | 14.8 | 24.0 |
| % IMPROVEMENT IN MONTH | 101% | 91.0% | 95% |
| TWO LOADS: PASSING LINK VS | | | |
| COMPETITOR'S STANDARD | | | |
| LINK | | | |

It is to be understood, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A flail chain comprising:
a plurality of interlocking chain links, at least one chain link being a passing link, the passing link having first and second segments and outer and inner perimeters, wherein the first segment is generally semi-circular and includes a weld section and the second segment includes a stabilizing portion on the outer perimeter opposite the weld section; wherein the first segment includes rounded portions on each side of the weld section having curved inner and outer perimeters; the second segment further including two rounded ends on each side of the stabilizing portion, the two rounded ends being continuous with the first segment; the stabilizing portion including at least two spaced apart contact points on the outer perimeter that can stabilize the link on a flat surface such that the link can slide and rest on the surface without rolling or changing its orientation relative to the surface.

2. The flail chain of claim 1, wherein, in operation, each passing link can rotate at least 180 degrees with respect to adjacent chain links.

3. The flail chain of claim 1, wherein the stabilizing portion is a substantially flattened portion.

4. The flail chain of claim 3, wherein the substantially flattened portion of the passing link has a length that is equal to or less than about one-third of the length of respective passing.

5. The flail chain of claim 3, wherein a length of the substantially flattened portion is at least about equal to a diameter of the wire material.

6. The flail chain of claim 3, wherein the passing link has an inner perimeter, wherein the shortest distance between the inner perimeter proximate the weld section to the inner perimeter proximate the substantially flattened portion is about equal to the shortest distance between the inner perimeter proximate one rounded end of the second segment to the other rounded end of the second segment.

7. The flail chain of claim 1, wherein all of the chain links are passing links.

8. A flail chain comprising:
a plurality of interlocking welded chain links each having a weld section, at least one link being a passing link; wherein each passing link is substantially round but for a substantially flattened section positioned about 180 degrees from the weld section.

9. The flail chain of claim 8, wherein, in operation, each passing link can rotate at least 180 degrees with respect to each adjacent chain link.

10. The flail chain of claim 8, wherein a length of the substantially flattened portion of the passing link is equal to or less than about one third of a length of the respective passing link.

11. The flail chain of claim 8, wherein the passing link has first and second segments, wherein the first segment is substantially semi-circular and includes a weld section and the second segment includes the substantially flattened portion;
the second segment further including two rounded ends on each side of the substantially flattened portion, the two rounded ends being continuous with the first segment.

12. The flail chain of claim 11, wherein the passing link includes a central opening defining an inner perimeter, wherein the shortest distance between the inner perimeter proximate the weld section to the inner perimeter proximate the substantially flattened portion is about equal to the shortest distance between the inner perimeter proximate one rounded end of the second segment to the other rounded end of the second segment.

13. The flail chain of claim 8, wherein each of the chain links are passing links.

14. A flail chain comprising:
a plurality of interlocking chain links, at least one chain link being a passing link having first and second segments, wherein the first segment is generally semi-circular and includes a weld section and the second segment includes a stabilizing portion on the outer perimeter generally opposite the weld section; the passing link further including two rounded portions on each side of the a stabilizing portion.

15. The flail chain of claim 14, wherein, in operation, each passing link can rotate at least 180 degrees with respect to adjacent chain links.

16. The flail chain of claim 14, wherein the stabilizing portion is a substantially flattened portion.

17. The flail chain of claim 16, wherein a length of the substantially flattened portion of the passing link that is less than one third of a length of the respective passing link.

18. The flail chain of claim 16, the weld section of the passing link is about 180 degrees from the substantially flattened portion of the passing link.

19. The flail chain of claim 16, wherein the passing link has a central opening defining an inner perimeter, wherein the shortest distance between the inner perimeter proximate the weld section to the inner perimeter proximate the substantially flattened portion is about equal to the shortest distance between the inner perimeter proximate one rounded end of the second segment to the other rounded end of the second segment.

20. The flail chain of claim 14, wherein all of the chain links are passing links.

21. A flail chain comprising:
a plurality of interconnected chain links; a least one of the plurality of chain links being a passing link made of wire material that has a substantially uniform diameter, which is welded together into a continuous strand of wire; the passing link having a weld section and an outer perimeter and an inner perimeter, the outer perimeter having at least one substantially flattened portion, wherein the substantially flattened portion on the outer perimeter is on a side of the passing link opposite the weld section; the passing link further including opposing end portions that are interconnected on one side by the wire material proximate the substantially flattened portion and on the other side by the weld section that joins the wire material together; wherein a radii of all portions of the inner perimeter of the passing link are sufficiently large to permit the passing link to have no two opposing side portions that are a distance apart from one another that is less than a distance equal to about two times the diameter of the wire material.

22. The flail chain of claim 21, wherein, in operation, each passing link can rotate at least 180 degrees with respect to adjacent chain links.

23. The flail chain of claim 21, wherein the substantially flattened portion of the passing link has a length that is equal to or less than about one-third of a length of the respective passing link.

24. The flail chain of claim 21, wherein the substantially flattened portion has a length that is at least equal to a diameter of the wire material.

25. The flail chain of claim 21, wherein the passing link has an inner perimeter, wherein the shortest distance between the inner perimeter proximate the weld section to the inner perimeter proximate the substantially flattened portion is about equal to the shortest distance between the inner perimeter proximate one rounded end of the second segment to the other rounded end of the second segment.

26. The debarking chain of claim 21, wherein all of the chain links are passing links.

27. A flail chain comprising:
a plurality of chain links; a least one of the plurality of chain links being a passing link made of a wire material that has a substantially uniform diameter, which is welded together into a continuous strand of wire material; the passing link having a weld section and an outer perimeter and an inner perimeter, the outer perimeter having at least one stabilizing portion, wherein the stabilizing portion on the outer perimeter is on a side of the passing link opposite the weld section; the passing link further including opposing end portions that are interconnected on one side by the wire material proximate the stabilizing portion and on the other side by the weld section that joins the wire material together; wherein the inner perimeter defines a central opening and the central opening has a height and a width that are equal to or greater than about two times the diameter of the wire material; the stabilizing portion including at least two spaced apart contact points on the outer perimeter that can stabilize the link on a flat surface such that the link can slide and rest on the surface without rolling or changing its orientation relative to the surface.

28. The flail chain of claim 27, wherein, in operation, the passing link can rotate at least 180 degrees with respect to adjacent chain links.

29. The flail chain of claim 27, wherein the stabilizing portion of the passing link is a substantially flattened portion that is equal to or less than about one-third of the length of respective passing link.

30. The flail chain of claim 29, wherein the substantially flattened portion is at least equal to a diameter of the wire material.

31. The flail chain of claim 30, wherein the passing link has an inner perimeter, wherein the shortest distance between the inner perimeter proximate the weld section to the inner perimeter proximate the substantially flattened portion is about equal to the shortest distance between the inner perimeter proximate one rounded end of the second segment to the other rounded end of the second segment.

32. The debarking chain of claim 27, wherein all of the chain links are passing links.

33. A method of manufacturing a flail chain, the method comprising the steps of:
providing a bulk length of wire material having a lead end;
feeding the lead end of the bulk length of wire material into a wire forming machine;
creating a plurality of chain link blanks in series by separating away a portion of wire material proximate the lead end of the length of wire material to create the respective chain link blanks, each of which has respective first and second ends;
consecutively bending each of the respective plurality of chain link blanks into unwelded formed links in series such that the respective first and second ends of each chain link blank are turned toward one another and there is a gap between the respective ends on one side of each of the respective unwelded formed links and a stabilizing portion on an outer perimeter of each of the respective unwelded formed links on the side opposite the gap; wherein the step of consecutively bending each of the chain link blanks includes creating an unwelded chain including a plurality of interlocking unwelded formed links from the consecutively bent plurality of chain link blanks; wherein the stabilizing portion includes at least two spaced apart contact points on the outer perimeter that can stabilize the respective unwelded formed link on a flat surface such that the respective unwelded formed link can slide and rest on the flat surface without rolling or changing its orientation relative to such flat surface; and
creating a series of flail chains each including a plurality of interlocking, welded passing links by transporting the unwelded chain to a welding machine where the gap of each of the plurality of interlocking unwelded formed links is welded in series such that each of the respective unwelded formed links becomes a welded passing link having first and second segments and outer and inner perimeters, wherein the first segment is generally semi-circular and includes a weld section and the second segment includes a stabilizing portion on the outer perimeter opposite the welded section, wherein the first segment includes rounded portions on each side of the welded section having curved inner and outer perimeters, the second segment further including two rounded ends on each side of the stabilizing portion, the two rounded ends being continuous with the first segment and the stabilizing portion including at least two spaced apart contact points on the outer perimeter that can stabilize the link on a flat surface such that the link can slide and rest on the surface without rolling or changing its orientation relative to such flat surface;
wherein a welding machine is provided and the welding machine includes a welding block having a longitudinal surface that is generally flat; and the step of creating includes a step of welding wherein each of the respective unwelded formed links are consecutively transported onto the longitudinal surface of the welding block so as to stabilize each of the respective unwelded formed links during the welding step such that the respective gaps are consecutively welded and a series of interlocking, welded passing links are created; and wherein, following the step of welding, the step of creating further includes a step of cutting wherein a series of the interlocking, welded passing links are cut to enable a series of flail chains to be separated from the series of interlocking, welded passing links created during the welding step.

34. The method of claim 33, wherein the step of transporting the unwelded chain to the welding machine includes drawing the unwelded chain along a flat surface under tension so that the orientation of each of the respective interlocking unwelded formed links is maintained as each of the series of interlocking unwelded formed links comes into contact with the flat surface.

35. The method of claim 33, wherein the step of transporting the unwelded chain to the welding machine includes drawing the unwelded chain through a V-shaped channel having at least one flat surface so that the orientation of each of the respective interlocking unwelded formed links is maintained as each of the respective interlocking unwelded formed links comes into contact with the flat surface.

36. The method of claim 33, wherein each chain link blank is formed such that the stabilized portion of each of the respective passing links is equal to or less than about one-third of a length of the respective passing link.

37. The method of claim 33, wherein each chain link blank is formed such that the stabilized portion of each of the respective passing links is at least about equal to a diameter of the wire material.

38. The method of claim 33, wherein each chain link blank is formed such that the stabilized portion of each of the respective passing links is a substantially flattened portion.

39. The method of claim 33, wherein the step of creating includes bending each consecutive chain link blank to at least partially encircle a portion of the previously bent unwelded chain link so that the respective unwelded formed links are consecutively interlocked.

40. The method of claim 39, wherein the gap and the stabilizing portion of each of the respective unwelded formed link are separated by a central opening defined in part by an inner perimeter of the unwelded formed link and each of the plurality of consecutive unwelded chain links are interlocked such that each of two adjacent unwelded formed chain links in the unwelded chain pass through the central opening of the unwelded chain link to which said adjacent chain links are adjacent.

41. A debarking device constructed for use to debark logs, each of which has an external layer of bark, the debarking device comprising:
a debarking drum; and
a plurality of flail chains, each of the flail chains being interconnected with the debarking drum; the debarking drum being constructed and arranged so that it can rotate at a high rate of speed around an axis so that at least a portion of at least one of the plurality of flail chains can strike any such log when such a log is brought into such close proximity to the debarking drum to permit such a portion of at least one of the plurality of flail chains to strike the log, wherein the bark can be separated from the log as a portion of at least one of the plurality of flail chains strike the log when the debarking drum is rotating; wherein the plurality of flail chains includes a plurality of interlocking chain links and at least one chain link being a passing link, the passing link having first and second segments and outer and inner perimeters, wherein the first segment is generally semi-circular and includes a weld section and the second segment includes a stabilizing portion on the outer perimeter opposite the weld section; wherein the first segment includes rounded portions on each side of the weld section having curved inner and outer perimeters; the second segment further including two rounded ends on each side of the stabilizing portion, the two rounded ends being continuous with the first segment; the stabilizing portion including at least two spaced apart contact points on the outer perimeter that can stabilize the link on a flat surface such that the link can slide and rest on the surface without rolling or changing its orientation relative to the surface.

42. The debarking device of claim 41, wherein a length of the stabilizing portion of each passing link is less than one third of the length of an outer perimeter of the respective passing link.

43. The debarking device of claim 41, wherein each passing link has first and second segments, wherein the first segment is substantially semi-circular and includes a weld section and the second segment includes a substantially flattened portion on the outside perimeter of the link opposite the weld section;
the second segment further including two rounded ends on each side of the substantially flattened portion, the two rounded ends being continuous with the first segment.

44. The debarking device of claim 41, wherein at least one flail chain includes a plurality of chain links, wherein all of the chain links are passing links.
